(19) United States
(12) Patent Application Publication
(10) Pub. No.: US 2024/0364569 A1
(43) Pub. Date: Oct. 31, 2024

(54) WAVEFORM CONSTRUCTION FOR CREST FACTOR REDUCTION

(71) Applicant: Texas Instruments Incorporated, Dallas, TX (US)

(72) Inventors: Raju Kharataram Chaudhari, Bangalore (IN); Aswath VS, Kannur (IN); Sriram Murali, Bangalore (IN); Jaiganesh Balakrishnan, Bangalore (IN); Sreenath Narayanan Potty, Bangalore (IN); Kapil Kumar, Bangalore (IN)

(21) Appl. No.: 18/632,062

(22) Filed: Apr. 10, 2024

(30) Foreign Application Priority Data
Apr. 28, 2023 (IN) 202341030809

(51) Int. Cl. H04L 27/26; H04B 1/04

(52) U.S. Cl. CPC H04L 27/2618; H04B 1/0475

(57) ABSTRACT

An example apparatus includes: crest factor reduction circuitry having a signal input and a peak cancellation waveform input; and peak cancellation waveform generator circuitry including: carrier profile analyzer circuitry having a signal input coupled to the signal input of the crest factor reduction circuitry, and having a carrier profile output; waveform construction circuitry having a carrier profile input coupled to the carrier profile output of the carrier profile analyzer circuitry, having a second input, and having a peak cancellation waveform output coupled to the peak cancellation waveform input of the crest factor reduction circuitry; and profile change detector circuitry having a carrier profile input coupled to the carrier profile output of the carrier profile analyzer circuitry, and having an output coupled to the second input of the waveform construction circuitry.

### CROSS-REFERENCE TO RELATED APPLICATION

This patent application claims the benefit of and priority to Indian Provisional Patent Application No. 202341030809 filed Apr. 28, 2023, which application is hereby incorporated herein by reference in its entirety.

### TECHNICAL FIELD

This description relates generally to circuits and, more particularly, to methods and apparatus to perform waveform construction for crest factor reduction.

### BACKGROUND

In signal transmission circuitry, to reduce a total cost of a radio, radio manufacturers may use low-cost power amplifiers (PAs) having limited linearity and power delivery. To overcome such limited linearity and power delivery, radio manufacturers may utilize digital crest factor reduction (CFR) and pre-distortion (DPD) to linearize the output from the PAs.

### SUMMARY

For methods and apparatus to perform waveform construction for crest factor reduction, an example apparatus includes crest factor reduction circuitry having a signal input and a peak cancellation waveform input; peak cancellation waveform generator circuitry including: carrier profile analyzer circuitry having a signal input coupled to the signal input of the crest factor reduction circuitry, and having a carrier profile output; waveform construction circuitry having a carrier profile input coupled to the carrier profile output of the carrier profile analyzer circuitry, having a second input, and having a peak cancellation waveform output coupled to the peak cancellation waveform input of the crest factor reduction circuitry; and profile change detector circuitry having a carrier profile input coupled to the carrier profile output of the carrier profile analyzer circuitry, and having an output coupled to the second input of the waveform construction circuitry. Other examples are described.

An example transmitter apparatus includes peak cancellation waveform generator circuitry having an input and an output, and configured to determine a carrier profile of an input signal at the input and provide a peak cancellation waveform at the output based on the carrier profile. The transmitter apparatus includes crest factor reduction circuitry having an input coupled to the output of the peak cancellation waveform generator circuitry, and having an output, the crest factor reduction circuitry configured to modify the input signal based on the peak cancellation waveform. The transmitter apparatus includes digital pre-distortion circuitry having an input coupled to the output of the crest factor reduction circuitry. Other examples are described.

Another example apparatus includes programmable circuitry configured to at least one of instantiate or execute machine-readable instructions to: generate a carrier profile of an input signal of transmitter circuitry, compare the carrier profile to a previous carrier profile, and update a peak cancellation waveform for crest factor reduction responsive to the comparison.

Other examples are described.

### BRIEF DESCRIPTION OF THE DRAWINGS

FIG. 1 is a block diagram of an example communication system in which example peak cancellation waveform (PCW) generator circuitry may be implemented.

FIG. 2 is a block diagram of an example communication system including the transmitter circuitry of FIG. 1.

FIG. 3 is a block diagram of an example of the transmitter circuitry of FIGS. 1 and 2.

FIG. 4 is a block diagram of an example of the PCW generator circuitry of FIG. 1.

FIG. 5 is a flowchart representative of example machine-readable instructions or example operations that may be executed, instantiated, or performed using an example programmable or non-programmable circuit implementation of the PCW generator circuitry of FIGS. 1 and 4 to generate peak cancellation waveforms.

FIG. 6 is a block diagram of an example implementation of the carrier profile analyzer (CPA) circuitry of FIG. 4.

FIG. 7 is a flowchart representative of example machine-readable instructions or example operations that may be executed, instantiated, or performed using an example programmable or non-programmable circuit implementation of the CPA circuitry of FIGS. 4 and 6 to determine signal carrier profiles of input signals.

FIG. 8A is a frequency grid showing an example power spectral density of an input signal.

FIG. 8B is a frequency grid showing example contiguous occupied bandwidth (OBW) spectra and an example inter-carrier gap between the OBW spectra corresponding to the power spectral density of FIG. 8A.

FIG. 8C is a frequency grid showing uniform power spectral density regions based on the OBW spectra of FIG. 8B.

FIG. 8D is a frequency grid showing minimalist bandwidth partitions corresponding to the uniform power spectral density regions of FIG. 8C.

FIG. 9 is a block diagram of an example of the waveform construction engine (WCE) circuitry of FIG. 4.

FIG. 10 is a flowchart representative of example machine-readable instructions or example operations that may be executed, instantiated, or performed using an example programmable or non-programmable circuit implementation of the WCE circuitry of FIGS. 4 and 9 to generate PCWs.

FIG. 11A is a signal plot of an example low-latency pulse cancelling template.

FIG. 11B is an example carrier bandwidth diagram showing passband-to-stopband attenuation.

FIG. 12 is a block diagram of an example of the profile change detector (PCD) circuitry of FIG. 4.

FIG. 13 is a flowchart representative of example machine-readable instructions or example operations that may be executed, instantiated, or performed using an example programmable or non-programmable circuit implementation of the PCD circuitry of FIGS. 4 and 12 to determine when a signal carrier profile of an input signal changes.

FIG. 14 is a block diagram of an example processing platform including programmable circuitry structured to execute, instantiate, or perform the example machine-readable instructions or perform the example operations of FIGS. 5, 7, 10, and 13 to implement the PCW generator circuitry of FIG. 4, the example CPA circuitry of FIG. 6, the example WCE circuitry of FIG. 9, or the example PCD circuitry of FIG. 12.

FIG. 15 is a block diagram of an example implementation of the programmable circuitry of FIG. 14.

FIG. 16 is a block diagram of another example implementation of the programmable circuitry of FIG. 14.

The drawings are not necessarily to scale. The same reference numbers or other reference designators are used in the drawings to designate the same or similar (functionally or structurally) features. Generally, the same reference numbers in the drawing(s) and this description refer to the same or like parts.

### DETAILED DESCRIPTION

Crest factor reduction (CFR) and digital pre-distortion (DPD) can be used together to linearize highly nonlinear, high bandwidth (BW) (e.g., 100 s of megahertz (MHz)), high-wattage (e.g., up to 100 watts (W)) power amplifiers (PAs) used in transmitter circuitry of base stations (e.g., Fifth Generation of Mobile Telephony (5G) base stations) and repeaters. A crest factor is a characteristic of a waveform representative of the peak amplitude of the waveform relative to its average value. The peak amplitude is the maximum positive or negative amplitude of the waveform. CFR is used to reduce the Peak-to-Average power Ratio (PAR, also referred to in the industry as PAPR) of a baseband signal before DPD is applied. For example, PAR is a measure indicative of the power of any peaks in a signal relative to the average power in the overall signal. Cancelling or decreasing peaks in a signal using CFR decreases the amount of power attributable to the peaks of the signal. Accordingly, a signal having undergone CFR exhibits a lower PAR because of peak cancellation/reduction than before the CFR process.

In examples described herein, a baseband signal is the input signal to a CFR process. A baseband signal includes a range of frequencies that encode information (e.g., audio, video, images, text, data, etc.) but have not yet been modulated onto a carrier wave for transmission. A carrier wave is a signal at a particular frequency (e.g., a center frequency) which, by itself, conveys no information. However, a carrier wave can be used to carry or transmit a baseband signal. For example, when a baseband signal is modulated onto a carrier wave, the resulting modulated carrier wave contains the information encoded in the baseband signal. Accordingly, the baseband signal and its information can be transmitted at the center frequency, and neighboring sideband frequencies, corresponding to the carrier wave. In a carrier wave, a sideband frequency is a frequency that diverges from the center frequency and corresponds to a baseband signal and its information modulated onto the carrier wave. Sideband frequencies account for the total bandwidth of a modulated carrier wave. In a symmetrical signal, sideband frequencies expand outward from the center frequency of the carrier wave in both higher-frequency and lower-frequency directions relative to the center frequency. A higher-frequency sideband is referred to as an upper sideband, and a lower-frequency sideband is referred to as a lower sideband.

By employing CFR to reduce PAR, the dynamic range of a PA can be better utilized because more power amplification can be applied to an overall input signal based on a lower likelihood that any particular peak will saturate the power threshold of the PA. Such a signal amplification strategy increases transmission efficiency by operating the PA at a higher root-mean square (RMS) power (e.g., continuous power).

CFR may be implemented in base station transmitters using Pulse-Cancelling CFR (PC-CFR). PC-CFR is a CFR technique that performs input envelope peak detection and peak cancellation. Input signal envelop crossings above a peak limit or peak threshold (commensurate with a PAR target) are monitored to detect peaks. A Peak Cancellation Waveform (PCW) is then added to the input signal to cancel or contain peaks.

Some CFR techniques employ off-line utility software to design a suitable PCW using a priori carrier profile information. However, loading the off-line-designed PCW is slow and cumbersome due to the number of data points needed to load a PCW. For example, loading a PCW can require inputting up to ˜192,000 bytes (e.g., 4000 complex samples, 4 channels, and 3 stages per channel).

In the case of repeaters, a priori transmit carrier profile information may be unknown for use in generating a PCW off-line. As such, a technique for repeaters involves the use of Windowed CFR (W-CFR). In W-CFR, a multiplicative technique is used in which peak regions are attenuated using a smoothing window. W-CFR is carrier profile agnostic. However, it is less effective than PC-CFR with respect to the PAR target. Also, W-CFR requires a higher PAR target by approximately 1 to 2 decibels (dB) relative to PC-CFR to achieve a similar error vector magnitude (EVM). EVM is a measure of in-band signal-to-noise ratio (SNR).

Unlike other techniques, examples described herein enable use of PC-CFR in both base stations and repeaters without requiring a priori knowledge of carrier profile information. Examples described herein monitor a baseband input signal to assess its carrier profile and construct a suitable PCW. Examples described herein couple a carrier profile analyzer (CPA), a waveform construction engine (WCE) (also referred to as waveform construction circuitry), and a profile change detector (PCD) to a CFR stage of transmitter circuitry. The CPA analyzes an input signal and identifies an underlying carrier profile. The WCE constructs a PCW based on the identified carrier profile. The PCD monitors for and detects changes in the carrier profile to trigger a reassessment and re-configuration of how PC-CFR is implemented, or to notify a host of profile changes.

Examples described herein dynamically detect changes in a signal carrier profile and dynamically re-configure CFR with an updated PCW. Accordingly, the described examples do not need a priori signal carrier profile for offline creation of a PCW. Since examples described herein monitor input signals for changes in their underlying carrier profiles, the described examples are highly scalable to changes in baseband signal characteristics and transmit power. Also, because examples described herein can be used to replace W-CFR with PC-CFR in repeaters, the described examples can reduce the PAR for a given EVM by 1-2 dB. In doing so, the lower PAR helps achieve higher output power for a given peak swing at the power amplifier, thereby improving coverage and range of base stations and repeaters. For example, the PAR can be increased by 1-2 dB, which is approximately 25% to 50% higher power. Also, examples described herein eliminate or substantially reduce slow and cumbersome loading of offline-created PCWs.

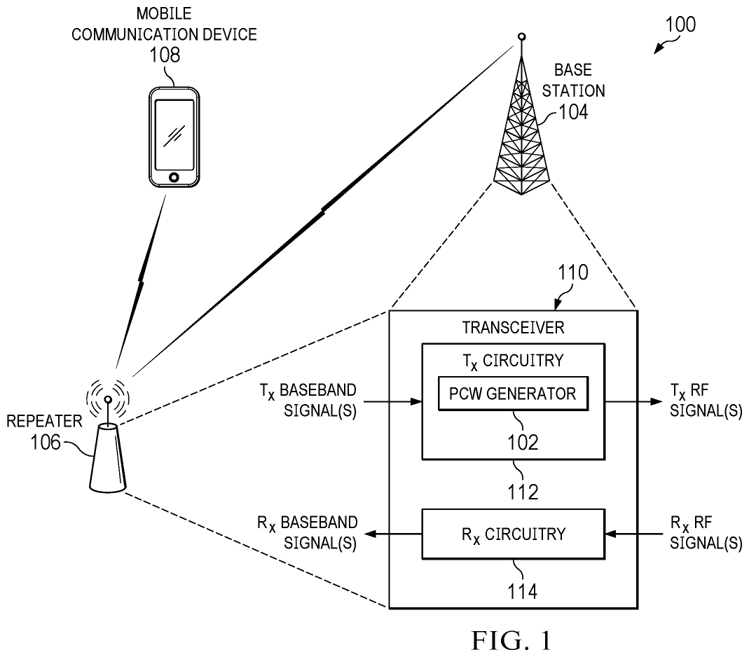

FIG. 1 is a block diagram of an example communication system 100 in which example PCW generator circuitry 102 may be implemented. In example FIG. 1, the communication system 100 is a wireless cellular communication system that includes an example base station 104 and an example repeater 106. In the communication system 100, the base station 104 transmits a communication signal (e.g., a radio frequency (RF) signal), which is received by the repeater 106 and relayed by the repeater 106 to a mobile communication device 108. In example FIG. 1, the base station 104 and the repeater 106 include corresponding transceivers substantially similar or identical to an example, transceiver 110 shown in FIG. 1. The transceiver 110 includes transmitter (Tx) circuitry 112 and receiver circuitry 114. The Tx circuitry 112 receives one or more transmit baseband signal(s) from, for example, a baseband processor. The one or more transmit baseband signal(s) include information (e.g., video, audio, text, data, etc.) to be transmitted. The Tx circuitry 112 modulates the baseband signal(s) onto one or more carrier signal(s) to form RF signal(s), and transmits the RF signal(s). Also, in example FIG. 1, the receive circuitry 114 receives one or more RF signal(s) from other base stations or repeaters and recovers baseband signal(s) from the received RF signal(s). The receiver circuitry 114 then provides the recovered baseband signal(s) to, for example, a baseband processor. As shown in example FIG. 1, the PCW generator circuitry 102 may be implemented in the Tx circuitry 112. The PCW generator circuitry 102 automatically assesses carrier profiles of input signals and generates corresponding peak cancellation waveforms, as described below, for use in cancelling peaks detected in the input signals.

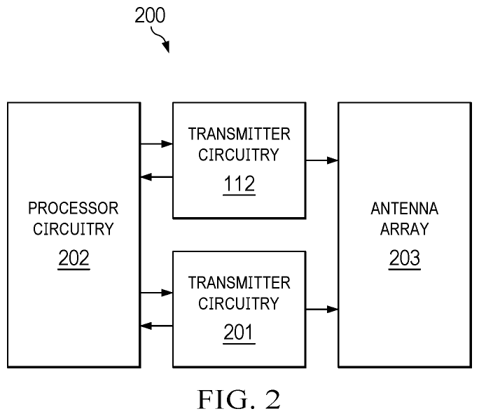

FIG. 2 is an example block diagram of a communication system 200. In the example of FIG. 2, the communication system 200 includes at least two instances of transmitter circuitry. For example, the communication system 200 includes the example Tx circuitry 112 and second example transmitter circuitry 201. In the example of FIG. 2, the communication system 200 also includes example processor circuitry 202 and an example antenna array 203.

In the illustrated example of FIG. 2, each of the Tx circuitry 112 and the transmitter circuitry 201 has a first output terminal, a second input terminal, and an input terminal. Also, the processor circuitry 202 has a first output terminal, a second output terminal, a first input terminal, and a second input terminal. In the example of FIG. 2, the antenna array 203 has a first input terminal and a second input terminal. As described above, an example frequency band may be divided into one or more channels where a channel refers to a frequency range within the frequency band. In the example of FIG. 2, the Tx circuitry 112 is to perform transmission in a first channel of a frequency band and the transmitter circuitry 201 is to perform transmission in a second channel of the frequency band (e.g., where the second channel is at least one of the same as or different than the first channel).

In the illustrated example of FIG. 2, each of the Tx circuitry 112 and the transmitter circuitry 201 is implemented by at least one digital circuit or analog circuit. In the example of FIG. 2, the first output terminal of the Tx circuitry 112 is coupled to the first input terminal of the processor circuitry 202 and the second output terminal of the Tx circuitry 112 is coupled to the first input terminal of the antenna circuitry 203. Also, the input terminal of the Tx circuitry 112 is coupled to the first output terminal of the processor circuitry 202. In the example of FIG. 2, the first output terminal of the transmitter circuitry 201 is coupled to the second input terminal of the processor circuitry 202 and the second output terminal of the transmitter circuitry 201 is coupled to the second input terminal of the antenna circuitry 203. Also, the input terminal of the transmitter circuitry 201 is coupled to the second output terminal of the processor circuitry 202.

In the illustrated example of FIG. 2, the processor circuitry 202 is implemented by a processor. For example, the processor circuitry 202 is implemented by a central processor unit (CPU). Also or alternatively, the processor circuitry 202 is implemented by a graphics processor unit (GPU), a digital signal processor (DSP), or custom hardware (e.g., implemented by at least one of an Application Specific Integrated Circuit (ASIC) or a Field Programmable Gate Array (FPGA)), among others. In the example of FIG. 2, the first output terminal of the processor circuitry 202 is coupled to the input terminal of the Tx circuitry 112 and the second output terminal of the processor circuitry 202 is coupled to the input terminal of the transmitter circuitry 201. Also, the first input terminal of the processor circuitry 202 is coupled to the first output terminal of the Tx circuitry 112 and the second input terminal of the processor circuitry 202 is coupled to the first output terminal of the transmitter circuitry 201.

In the illustrated example of FIG. 2, the antenna array 203 includes at least two discrete antennas. For example, the antenna array 203 includes at least two sector antennas. In some examples, the antenna array 203 includes at least two integrated antennas. For example, an integrated antenna includes at least one of a patch antenna, a microstrip antenna, an antenna-on-package (AoP) antenna, among others. In the example of FIG. 2, the first input terminal of the antenna array 203 is coupled to the output terminal of the Tx circuitry 112 and the second input terminal of the antenna array 203 is coupled to the output terminal of the transmitter circuitry 201.

In the illustrated example of FIG. 2, the processor circuitry 202 generates one or more digital signals to be transmitted via the antenna array 203. In the example of FIG. 2, the Tx circuitry 112 converts a first digital signal (e.g., a base-band signal in a first channel) to a radio frequency (RF) band signal to be transmitted via an antenna of the antenna array 203.

Advantageously, the Tx circuitry 112 applies CFR and DPD correction to the first digital signal to counteract non-linearity of PA circuitry of the Tx circuitry 112. In the example of FIG. 2, the transmitter circuitry 201 operates similarly to the Tx circuitry 112.

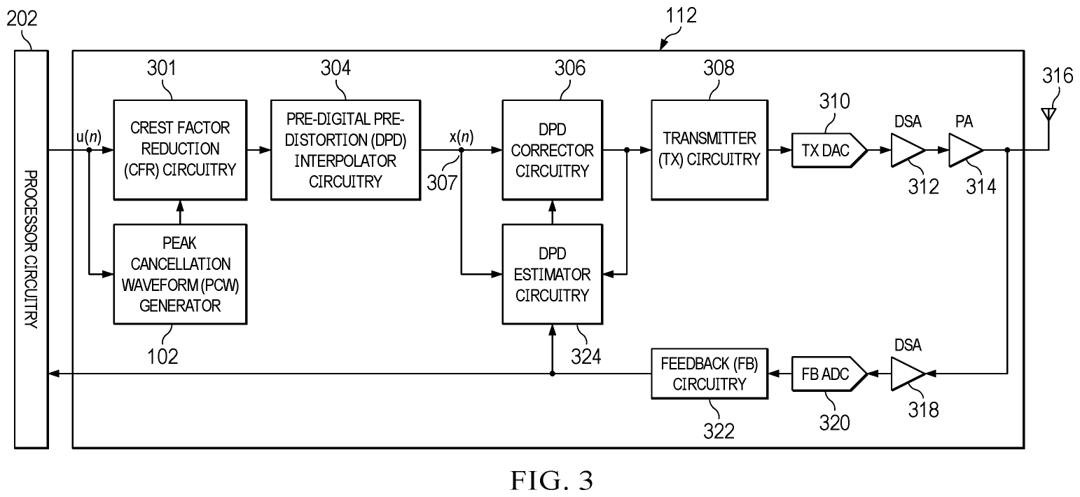

FIG. 3 is a block diagram of an example implementation of the Tx circuitry 112 of FIG. 2. In example FIG. 3, as in other example figures described herein, illustrated connections between components does not imply the absence of other connections. Instead, examples described herein and illustrated in the figures may be implemented to include connections between components and additional components even if such connections or components are not shown in the figures. In the example of FIG. 3, the Tx circuitry 112 includes example crest factor reduction (CFR) circuitry 301, the PCW generator circuitry 102 of FIG. 1, example pre-digital pre-distortion (DPD) interpolator circuitry 304, example digital pre-distortion (DPD) corrector circuitry 306, example transmitter circuitry 308, example transmitter digital-to-analog converter (DAC) circuitry 310, first example digital step attenuator (DSA) circuitry 312, and example power amplifier (PA) circuitry 314. In the example of FIG. 3, the Tx circuitry 112 is associated with an example antenna 316. For example, the antenna 316 is a first antenna of the antenna array 203. The Tx circuitry 112 also includes second example DSA circuitry 318, example feedback analog-to-digital converter (ADC) circuitry 320, example feedback circuitry 322, and example digital pre-distortion (DPD) estimator circuitry 324.

In the illustrated example of FIG. 3, each of the PCW generator circuitry 102, the pre-DPD interpolator circuitry 304, the transmitter circuitry 308, the transmitter DAC circuitry 310, the DSA circuitry 312, the PA circuitry 314, the DSA circuitry 318, the feedback ADC circuitry 320, and the feedback circuitry 322 has an output terminal and an input terminal. Also, in the example of FIG. 3, each of the CFR circuitry 301 and the DPD corrector circuitry 306 has a first input terminal, a second input terminal, and an output terminal. The example DPD estimator circuitry 324 also has a first input terminal, a second input terminal, a third input terminal, and an output terminal.

As described above, the processor circuitry 202 is implemented by a processor. For example, the processor circuitry 202 is implemented by a CPU. Also or alternatively, the processor circuitry 202 is implemented by a GPU, a DSP, or custom hardware (e.g., implemented by at least one of an ASIC or an FPGA), among others. In the example of FIG. 3, an output terminal of the processor circuitry 202 (e.g., the first output terminal) is coupled to the first input terminal (e.g., a signal input) of the CFR circuitry 301 and to the input terminal of the PCW generator circuitry 102. An input terminal (e.g., the first input terminal) of the processor circuitry 202 is coupled to the output terminal of the feedback circuitry 322.

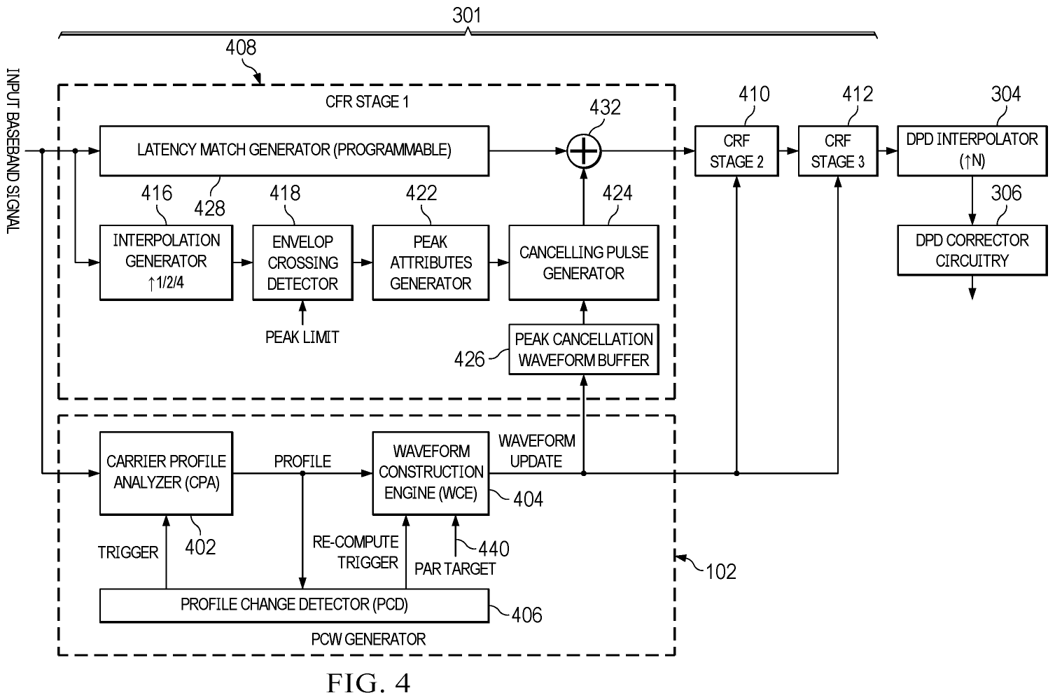

In the illustrated example of FIG. 3, the CFR circuitry 301 and the PCW generator circuitry 102 are implemented by digital circuitry (e.g., discrete digital hardware components or programmable circuitry). The CFR circuitry 301 is provided to analyze input baseband signals to perform input envelope peak detection and peak cancellation on those input signals. In the example of FIG. 3, the output terminal of the PCW generator 102 is coupled to the second input terminal (e.g., a peak cancellation waveform input) of the CFR circuitry 301. The PCW generator circuitry 102 generates peak cancellation waveforms (PCWs) for input baseband signals. The CFR circuitry 301 uses the PCWs generated by the PCW generator circuitry 102 to perform peak cancellation on the input signals by generating cancelling pulse signals based on PCWs from the PCW generator circuitry 102 and applying the cancelling pulse signals to corresponding portions of input signals. The CFR circuitry 301 and the PCW generator circuitry 102 are further described below in connection with FIG. 4.

In the illustrated example of FIG. 3, the output terminal of the CFR circuitry 301 is coupled to the input terminal of the pre-DPD interpolator circuitry 304. In the illustrated example of FIG. 3, the pre-DPD interpolator circuitry 304 is implemented by digital circuitry (e.g., discrete digital hardware components or programmable circuitry). In the example of FIG. 3, the output terminal of the pre-DPD interpolator circuitry 304 is coupled to the first input terminal of the DPD corrector circuitry 306 and the first input terminal of the DPD estimator circuitry 324. In some examples, the output terminal of the pre-DPD interpolator circuitry 304 is referred to as an example DPD terminal 307. In the example of FIG. 3, the DPD corrector circuitry 306 of FIG. 3 is implemented by digital circuitry (e.g., discrete digital hardware components or programmable circuitry). Also, the output terminal of the DPD corrector circuitry 306 is coupled to the input terminal of the transmitter circuitry 308 and the third input terminal of the DPD estimator circuitry 324. In the example of FIG. 3, the first input terminal of the DPD corrector circuitry 306 is coupled to the output terminal of the pre-DPD interpolator circuitry 304 (e.g., the DPD terminal 307) and the second input terminal of the DPD corrector circuitry 306 is coupled to the output terminal of the DPD estimator circuitry 324.

In the illustrated example of FIG. 3, the transmitter circuitry 308 is implemented by at least one of analog circuitry or digital circuitry (e.g., discrete digital hardware components or programmable circuitry). Also, in the example of FIG. 3, the output terminal of the transmitter circuitry 308 is coupled to the input terminal of the transmitter DAC circuitry 310 and the input terminal of the transmitter circuitry 308 is coupled to the output terminal of the DPD corrector circuitry 306. In the example of FIG. 3, the transmitter DAC circuitry 310 is implemented by at least one of digital circuitry (e.g., discrete digital hardware components or programmable circuitry) or analog circuitry. Also, in the example of FIG. 3, the output terminal of the transmitter DAC circuitry 310 is coupled to the input terminal of the DSA circuitry 312 and the input terminal of the transmitter DAC circuitry 310 is coupled to the output terminal of the transmitter circuitry 308.

In the illustrated example of FIG. 3, the DSA circuitry 312 is implemented by at least one of digital circuitry (e.g., discrete digital hardware components or programmable circuitry) or analog circuitry. Also, in the example of FIG. 3, the output terminal of the DSA circuitry 312 is coupled to the input terminal of the PA circuitry 314 and the input terminal of the DSA circuitry 312 is coupled to the output terminal of the transmitter DAC circuitry 310. In the example of FIG. 3, the PA circuitry 314 is implemented by at least one of digital circuitry (e.g., discrete digital hardware components or programmable circuitry) or analog circuitry. Also, in the example of FIG. 3, the output terminal of the PA circuitry 314 is coupled to the antenna 316 and the input terminal of the DSA circuitry 318. In the example of FIG. 3, the input terminal of the PA circuitry 314 is coupled to the output terminal of the DSA circuitry 312.

In the illustrated example of FIG. 3, the antenna 316 is implemented by a discrete antenna. For example, the antenna 316 is implemented by a sector antenna. In some examples, the antenna 316 is an integrated antenna. For example, the antenna 316 can be implemented by at least one of a patch antenna, a microstrip antenna, an antenna-on-package (AoP) antenna, among others. In the example of FIG. 3, the DSA circuitry 318 is implemented by at least one of digital circuitry (e.g., discrete digital hardware components or programmable circuitry) or analog circuitry. Also, in the example of FIG. 3, the output terminal of the DSA circuitry 318 is coupled to the input terminal of the feedback ADC circuitry 320 and the input terminal of the DSA circuitry 318 is coupled to the output terminal of the PA circuitry 314.

In the illustrated example of FIG. 3, the feedback ADC circuitry 320 is implemented by at least one of digital circuitry (e.g., discrete digital hardware components or programmable circuitry) or analog circuitry. In the example of FIG. 3, the output terminal of the feedback ADC circuitry 320 is coupled to the input terminal of the feedback circuitry 322 and the input terminal of the feedback ADC circuitry 320 is coupled to the output terminal of the DSA circuitry 318. Also, in the example of FIG. 3, the feedback circuitry 322 is implemented by at least one of analog circuitry or digital circuitry (e.g., discrete digital hardware components or programmable circuitry). In the example of FIG. 3, the output terminal of the feedback circuitry 322 is coupled to the input terminal of the processor circuitry 202 and the second input terminal of the DPD estimator circuitry 324. Also, in the example of FIG. 3, the input terminal of the feedback circuitry 322 is coupled to the output terminal of the feedback ADC circuitry 320.

In the illustrated example of FIG. 3, the DPD estimator circuitry 324 is implemented by digital circuitry (e.g., discrete digital hardware components or programmable circuitry). In the example of FIG. 3, the output terminal of the DPD estimator circuitry 324 is coupled to the second input terminal of the DPD corrector circuitry 306. Also, in the example of FIG. 3, the first input terminal of the DPD estimator circuitry 324 is coupled to the output terminal of the pre-DPD interpolator circuitry 304 (e.g., the DPD terminal 307), the second input terminal of the DPD estimator circuitry 324 is coupled to the output terminal of the feedback circuitry 322, and the third input terminal of the DPD estimator circuitry 324 is coupled to the output terminal of the DPD corrector circuitry 306.

In example operation, the processor circuitry 202 generates a digital signal (e.g., u(n)) to be transmitted via the antenna 316. Also, the pre-DPD interpolator circuitry 304 oversamples the digital signal at the output of the CFR circuitry 301 to avoid the effects of aliasing that may result from bandwidth expansion during pre-distortion of the digital signal (e.g., x(n)). For example, if the input signal (e.g., u(n)) from the processor circuitry 202 is sampled at about 250 MSPS (e.g., the input signal has a bandwidth of 200 MHz), then the pre-DPD interpolator circuitry 304 oversamples the input signal to about 750 MSPS (e.g., with an interpolation factor of 3).

In the illustrated example of FIG. 3, the DPD corrector circuitry 306 generates a pre-distorted digital signal y(n) as described in Equation 1 below. Manufacturers may use a wide variety of DPD models to define an inverse function ƒ⁻¹( ). One such model is a generalized memory polynomial (GMP) model. The GMP model is illustrated below in Equation 1.

$$y ( n ) = x ( n ) + {\sum }_{k = 1}^{M} x ( n - {l}_{1} ( k ) ) * {f}_{k} ( \vert x ( n - {l}_{2} ( k ) ) \vert ) \qquad Equation 1$$

In the example of Equation 1, x(n) represents an input signal, y(n) represents a pre-distorted version of the input signal, and Ix(n)I represents a function to compute the envelope of x(n). For example, |x(n)| can be determined by computing the square root of the sum of the squared real and squared imaginary components of x(n) (e.g.,

$$\vert x ( n ) \vert = \sqrt{{Re ( x ( n ) )}^{2} + {Im ( x ( n ) )}^{2}} ) .$$

In Equation 1, l₁(k) and l₂(k) represent delays (e.g., at least one of positive or negative) applied to x(n) and |x(n)|, respectively. Also, in Equation 1, the non-linearity of PA circuitry is modeled by M non-linear functions ƒₖ( ). In Equation 1, ƒₖ(|x(n−l₂(k))|) represents an output of a non-linear function indexed by |x(n−l₂(k))|.

In the illustrated example of FIG. 3, the processor circuitry 202 programs the DPD corrector circuitry 306 at startup of the communication system 200 to compensate for non-linearity of the PA circuitry 314. For example, the processor circuitry 202 programs the DPD corrector circuitry 306 based on the DPD model implemented by the DPD corrector circuitry 306 at startup of the communication system 200. Also, the processor circuitry 202 programs delay circuitry of the DPD corrector circuitry 306 at startup of the communication system 200 based on a DPD model implemented by the DPD corrector circuitry 306.

Although the PCW generator circuitry 102, the CFR circuitry 301, the pre-DPD interpolator circuitry 304, the DPD corrector circuitry 306, and the DPD estimator circuitry 324 are shown separate from the processor circuitry 202, in some examples, one or more of the PCW generator circuitry 102, the CFR circuitry 301, the pre-DPD interpolator circuitry 304, the DPD corrector circuitry 306, or the DPD estimator circuitry 324 may be configured by the processor circuitry 202.

In the illustrated example of FIG. 3, the transmitter circuitry 308 interpolates the pre-distorted signal (e.g., y(n)) generated by the DPD corrector circuitry 306 to introduce additional data points. For example, the additional data points increase the sample rate of the pre-distorted signal (e.g., y(n)) signal. The example transmitter circuitry 308 at least one of up samples (e.g., adds data points to, etc.) or up converts (e.g., converts a base-band signal to at least one of an intermediate frequency (IF) band signal or RF band signal, etc.) the pre-distorted signal (e.g., y(n)). In the example of FIG. 3, the transmitter DAC circuitry 310 converts the signal generated by the transmitter circuitry 308 from a digital signal to an analog signal. As a result, information transmitted via the antenna 316 is encoded continuously across a range of voltages rather than a discrete set of voltages.

In the illustrated example of FIG. 3, the DSA circuitry 312 attenuates the signal generated by the transmitter DAC circuitry 310 so that the PA circuitry 314 outputs a consistent amount of power. In particular, the DSA circuitry 312 attenuates the signal generated by the transmitter DAC circuitry 310 based on the gain of the PA circuitry 314, which may change based on temperature. The DSA circuitry 312 also provides the attenuated signal to the PA circuitry 314, which amplifies the signal for transmission via the antenna 316.

In the illustrated example of FIG. 3, the DSA circuitry 318 receives an analog signal from the PA circuitry 314 and attenuates the signal. In some examples, the DSA circuitry 318 attenuates the analog signal based on at least one operating parameter of the feedback ADC circuitry 320. In the example of FIG. 3, the feedback ADC circuitry 320 converts the attenuated signal generated by the DSA circuitry 318 from an analog signal to a digital signal. Also, the feedback circuitry 322 decimates (e.g., down converts, down samples, removes data points from, etc.) the digital signal. As a result, the digital signal generated by the feedback circuitry 322 can be fed back to and interpreted by the DPD estimator circuitry 324 and the processor circuitry 202.

When operating in a high efficiency range, the PA circuitry 314 amplifies analog signals received from the DSA circuitry 312 but also distorts the analog signals as described above. Advantageously, the DPD corrector circuitry 306 pre-distorts input signals from the processor circuitry 202 to counteract distortion introduced by the PA circuitry 314. As such, analog signals transmitted via the antenna 316 are scaled versions of the signal generated by the processor circuitry 302. As described above, as the temperature of or input signal profile to the PA circuitry 314 changes, the non-linearity of the PA circuitry 314 can change. As such, the DPD estimator circuitry 324 monitors signals output from the PA circuitry 314 and adjusts at least one value of a non-linear function stored in the DPD corrector circuitry 306 to track changes in the non-linearity of the PA circuitry 314. For example, the DPD estimator circuitry 324 evaluates a signal generated by the PA circuitry 314 as compared to the oversampled signal input to and pre-distorted signal output from the DPD corrector circuitry 306. Based on the comparison, the DPD estimator circuitry 324 estimates at least one updated value of a non-linear function stored in the DPD corrector circuitry 306.

The example components of FIG. 3 may be included in the same integrated circuit (IC) package or in two or more separate IC packages. For example, digital circuitry components may be included in one or more digital ICs and analog circuitry components may be included in or more analog ICs. In some examples, the CFR circuitry 301 is implemented in a first IC and the PCW generator circuitry 102 is implemented in a second IC. In other examples, both of the CFR circuitry 301 and the PCW generator circuitry 102 are implemented in the same IC. In some such examples, the CFR circuitry 301 and the PCW generator circuitry 102 may be implemented in a first IC and the DPD corrector circuitry 306 may be implemented in a second IC.

FIG. 4 is a block diagram of an example implementation of the PCW generator circuitry 102 of FIGS. 1 and 3 coupled to the crest factor reduction (CFR) circuitry 301 of the Tx circuitry 112 of FIGS. 1-3. The PCW generator circuitry 102 and the CFR circuitry 301 of FIG. 4 may be instantiated (e.g., creating an instance of, bring into being for any length of time, materialize, implement, etc.) by programmable circuitry such as a Central Processor Unit (CPU) executing first instructions. Also or alternatively, the PCW generator circuitry 102 and the CFR circuitry 301 of FIG. 2 may be instantiated (e.g., creating an instance of, bring into being for any length of time, materialize, implement, etc.) by (i) an Application Specific Integrated Circuit (ASIC) or (ii) a Field Programmable Gate Array (FPGA) structured or configured in response to execution of second instructions to perform operations corresponding to the first instructions. Some or all of the circuitry of FIG. 2 may, thus, be instantiated at the same or different times. Some or all of the circuitry of FIG. 2 may be instantiated, for example, in one or more threads executing concurrently on hardware or in series on hardware. Moreover, in some examples, some or all of the circuitry of FIG. 2 may be implemented by microprocessor circuitry executing instructions or FPGA circuitry performing operations to implement one or more virtual machines or containers.

The PCW generator circuitry 102 includes example carrier profile analyzer (CPA) circuitry 402, an example waveform construction engine (WCE) 404 (also referred to as waveform construction circuitry 404 and WCE circuitry 404), and example profile change detector (PCD) circuitry 406. The CFR circuitry 301 includes an example first CFR stage 408, an example second CFR stage 410, and an example third CFR stage 412. In example FIG. 4, the third CFR stage 412 is coupled to the pre-DPD interpolator circuitry 304 of FIG. 3 to interpolate an input signal to a DPD rate after having undergone CFR. The pre-DPD interpolator circuitry 304 is provided to interpolate the input signal in preparation for processing of the input signal by the DPD corrector circuitry 306 (FIG. 3). The pre-DPD interpolator circuitry 304 adds additional samples to an input signal to increase the sample frequency of the signal. The DPD corrector circuitry 306 generates a pre-distorted version y(n) of the input signal based on, for example, Equation 1 above. In example FIG. 4, the second CFR stage 410 and the third CFR stage 412 are provided to perform additional crest factor reduction. For example, peaks may remain in the input signal after being processed by the first CFR stage 408 due to peaks not being detected by the first CFR stage 408, peaks being inadvertently introduced by the pulse cancelling performed by the first CFR stage 408, or peaks introduced or re-introduced as noise in the input signal as it propagates through the first CFR stage 408. Although three CFR stages 408, 410, 412 are shown, examples described herein may be implemented in connection with fewer or more CFR stages.

The first CFR stage 408 is substantially similar or identical to the second CFR stage 410 and the third CFR stage 412. For purposes of brevity, details of only the first CFR stage 408 are shown in FIG. 4 and described below. The first CFR stage 408 includes example interpolation generator circuitry 416, example envelope crossing detector circuitry 418, example peak attributes generator circuitry 422, example cancelling pulse generator circuitry 424, example peak cancellation waveform buffer circuitry 426, example latency match generator circuitry 428, and example summer circuitry 432. Each of the interpolation generator circuitry 416, the envelope crossing detector circuitry 418, the peak attributes generator circuitry 422, the peak cancellation waveform buffer circuitry 426, and the example latency match generator circuitry 428 has an input terminal and an output terminal. Each of the cancelling pulse generator circuitry 424 and the example summer circuitry 432 has a first input terminal, a second input terminal, and an output terminal.

The input terminal of the interpolation generator circuitry 416 is coupled to the input terminal of the latency match generator circuitry 428 at an input terminal of the first CFR stage 408. The output terminal of the interpolation generator circuitry 416 is coupled to an input terminal of the envelope crossing detector circuitry 418. The output terminal of the envelope crossing detector circuitry 418 is coupled to the input terminal of the peak attributes generator circuitry 422. The output terminal of the peak attributes generator circuitry 422 is coupled to the first input terminal of the cancelling pulse generator circuitry 424. The second input terminal of the cancelling pulse generator circuitry 424 is coupled to the peak cancellation waveform buffer circuitry 426. The output terminal of the cancelling pulse generator circuitry 424 is coupled to the first input terminal of the summer circuitry 432. The output terminal of the latency match generator circuitry 428 is coupled to the second input terminal of the summer circuitry 432.

The interpolation generator circuitry 416 and the latency match generator circuitry 428 concurrently receive an input baseband signal from, for example, a baseband processor (e.g., the processor circuitry 202 of FIGS. 2 and 3). The interpolation generator circuitry 416 generates interpolated samples for the input baseband signal by up-sampling original samples of the input baseband signal based on an up-sampling frequency. In this manner, a resolution of the digital representation of the input baseband signal can be increased by representing the input baseband signal using its original samples and the interpolated samples. In some examples, the interpolation generator circuitry 416 may be bypassed or omitted when a resolution of the input baseband signal is not to be increased. In some examples, the interpolation generator circuitry 416 is instantiated by programmable circuitry executing interpolation generator instructions.

The envelope crossing detector circuitry 418 is provided to monitor amplitudes of peaks of the input baseband signal in the time domain to detect when a peak exceeds an amplitude threshold. An amplitude threshold value may be selected based on a maximum that is desired for any particular peak that would allow a PA (e.g., the PA circuitry 314 of FIG. 3) to apply sufficient gain to a resulting RF signal for optimum transmission quality. A target transmission quality can be one that satisfies a target signal-to-noise ratio (SNR) for the RF signal. In signal transmissions, a lower SNR is indicative of a poor signal quality because it indicates that the power of the information-carrying signal in an RF signal is low relative to the power of noise in the RF signal. However, a higher SNR is indicative of a better signal quality because it indicates that the power of the information-carrying signal in the RF signal is high relative to the power of noise in the RF signal. In some examples, the envelope crossing detector circuitry 418 is instantiated by programmable circuitry executing envelope crossing detector instructions.

The peak attributes generator circuitry 422 is provided to generate attributes of peaks that are detected in input baseband signals by the envelope crossing detector circuitry 418. Example peak attributes generated by the peak attributes generator circuitry 422 include position, amplitude, and phase. In some examples, the peak attributes generator circuitry 422 is instantiated by programmable circuitry executing peak attributes generator instructions.

The cancelling pulse generator circuitry 424 obtains the peak attributes generated by the peak attributes generator circuitry 422 and obtains a peak cancellation waveform (PCW) from the peak cancellation waveform buffer circuitry 426. The cancelling pulse generator circuitry 424 modifies or adjusts the PCW based on the peak attributes to generate a cancelling pulse signal that aligns with a corresponding peak that is to be reduced or eliminated in the input baseband signal. For example, the PCW can be provided for a center frequency and bandwidth of the input baseband signal so that the PCW can be used to reduce or eliminate a peak at that particular center frequency and bandwidth in the input baseband signal. To more precisely customize the PCW to align with the detected peak at the input baseband signal, the cancelling pulse generator circuitry 424 uses the peak attributes from the peak attributes generator circuitry 422 to shape and shift the PCW to generate a cancelling pulse signal having a more exact fit to the peak detected by the envelope crossing detector circuitry 418 in the input signal. Modifying the PCW in this manner substantially reduces or eliminates the likelihood of affecting neighboring portions of the input baseband signal when the cancelling pulse signal is applied to the input signal to reduce or eliminate a detected peak. In some examples, the cancelling pulse generator circuitry 424 is instantiated by programmable circuitry executing cancelling pulse generator instructions.

The latency match generator circuitry 428 creates a delay in the input signal of the first CFR stage 408 to compensate for delay introduced by the interpolation generator circuitry 416, the envelope crossing detector circuitry 418, the peak attributes generator circuitry 422, and the cancelling pulse generator circuitry 424. For example, the delay can be equal to half of the cancellation waveform length or the peak location (nₚ) in the input signal. In this manner, the cancelling pulse signal generated by the cancelling pulse generator circuitry 424 aligns with a corresponding peak location in a portion of an input signal received in the first CFR stage 408. Based on this alignment, the summer circuitry 432 applies the cancelling pulse signal to the correct time-aligned portion of the input signal at which a peak is detected. The latency match generator circuitry 428 may be implemented using a FIFO, tapped delay line, memory, or any other suitable circuit.

The summer circuitry 432 obtains the input signal from the latency match generator circuitry 428 and obtains the cancelling pulse signal from the cancelling pulse generator circuitry 424. The summer circuitry 432 sums the input signal with the cancelling pulse signal to reduce or eliminate a detected peak in the input signal. An example FIG. 4, the summer circuitry 432 passes the resulting signal to the second CFR stage 410. The second CFR stage 410 performs a similar process on the received signal and provides a resulting signal to the third CFR stage 412. The third CFR stage 412 performs a similar process on its received signal and provides a resulting signal to the DPD interpolator circuitry 304. However, if the crest factor reduction circuitry 301 includes only the first CFR stage 408 (and not the second CFR stage 410 or the third CFR stage 412), the first CFR stage 408 provides the resulting signal from the summer circuitry 432 directly to the DPD interpolator circuitry 304.

Turning to the PCW generator circuitry 102 shown in example FIG. 4, the CPA circuitry 402 has a first input terminal (e.g., a signal input) that is coupled to a first input terminal (e.g., a signal input) of the first CFR stage 408, and has a second input terminal and an output terminal (e.g., a carrier profile output). The WCE circuitry 404 has a first input terminal (e.g., a carrier profile input) coupled to the output terminal (e.g., the carrier profile output) of the CPA circuitry 402, and has a second input terminal and an output terminal (e.g., a peak cancellation waveform output). The PCD circuitry 406 has an input terminal (e.g., a carrier profile input) coupled to the output terminal (e.g., the carrier profile output) of the CPA circuitry 402 and has a first output terminal coupled to the second input terminal of the WCE circuitry 404. The PCD circuitry 406 also has a second output terminal coupled to the second input terminal of the CPA circuitry 402. The output terminal (e.g., the peak cancellation waveform output) of the WCE circuitry 404 is coupled to a second input terminal (e.g., a peak cancellation waveform input) of the first crest factor reduction stage circuitry 408. For example, the output terminal of the WCE circuitry 404 is coupled to the input terminal of the peak cancellation waveform buffer circuitry 426 of the first crest factor reduction stage circuitry 408 so that the peak cancellation waveform buffer circuitry 426 can store PCWs generated by the WCE circuitry 404 for use by the first crest factor reduction stage circuitry 408.

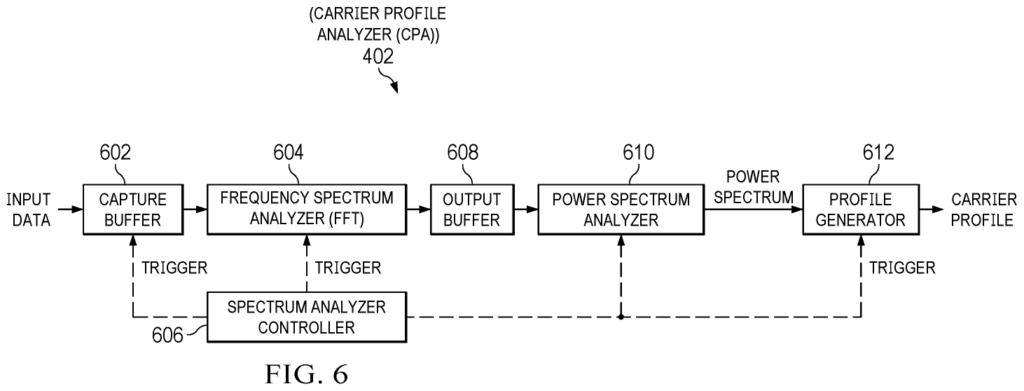

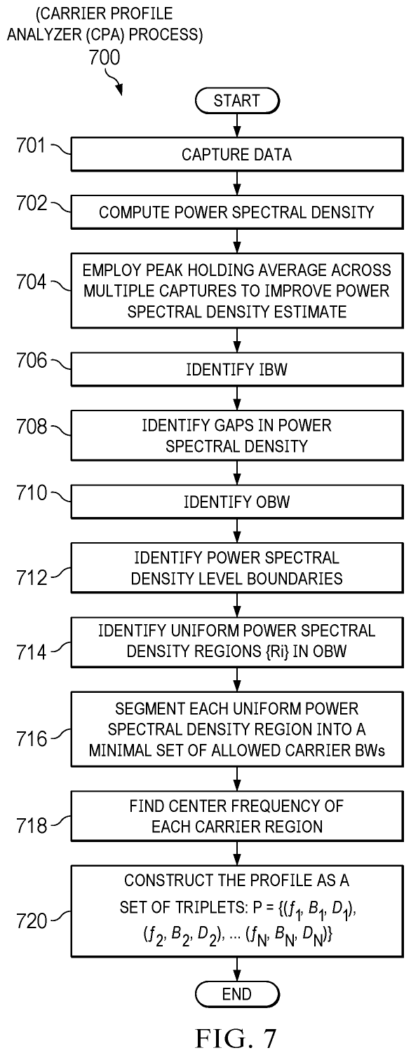

The CPA circuitry 402 generates a carrier profile of an input signal obtained from the input terminal of the first CFR stage 408 as described below in connection with FIGS. 6 and 7. In example FIG. 4, the input signal is a baseband signal. The range of frequencies in a baseband signal can be characterized based on a center frequencies (f) and corresponding bandwidths (B) and power spectral densities (D). The CPA circuitry 402 analyzes consecutive portions of the input signal to identify the characteristics (f, B, D) of each portion. For each portion, the CPA circuitry 402 generates a corresponding carrier profile as a set of triplets. The set of triplets in a carrier profile specify center frequencies, bandwidths, and corresponding power spectral densities for the range of frequencies in a portion of the input signal (e.g., a carrier profile=set of (center frequency (f), bandwidth (B), power spectral density (D)) triplets represented as {(f_{c1}, B₁, D₁), (f_{c2}, B₂, D₂), . . . (f_{cN}, B_{N}, D_{N})}).

The CPA circuitry 402 generates carrier profiles for use in customizing peak cancellation waveforms for the specific characteristics of different portions of an input signal. Adding cancelling pulses (based on peak cancellation waveforms) to input signals can impact key transmit signal quality metrics of the input signals, such as, EVM (a measure of in-band SNR) and adjacent channel leakage ratio (ACLR). As used herein, ACLR is a measure of spectral emission compliance (e.g., power leakage in an adjacent frequency band of a signal). The carrier profiles generated by the CPA circuitry 402 facilitate keeping EVM and ACLR within transmit specification limits based on peak cancellation waveforms generated by the WCE circuitry 404 using the carrier profiles.

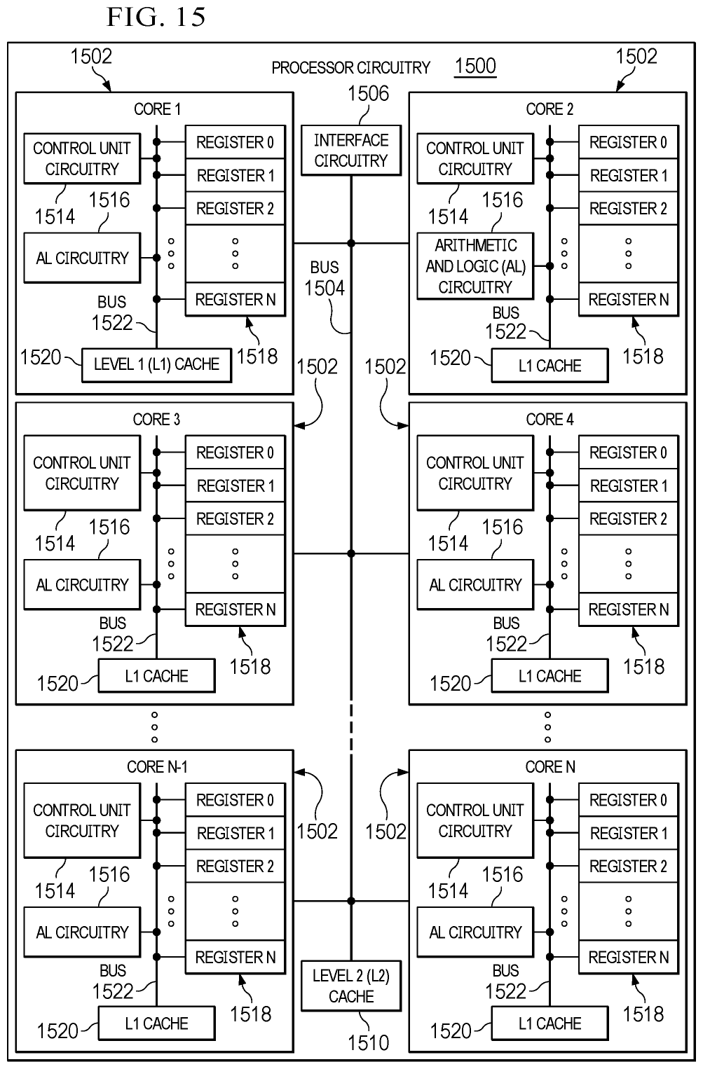

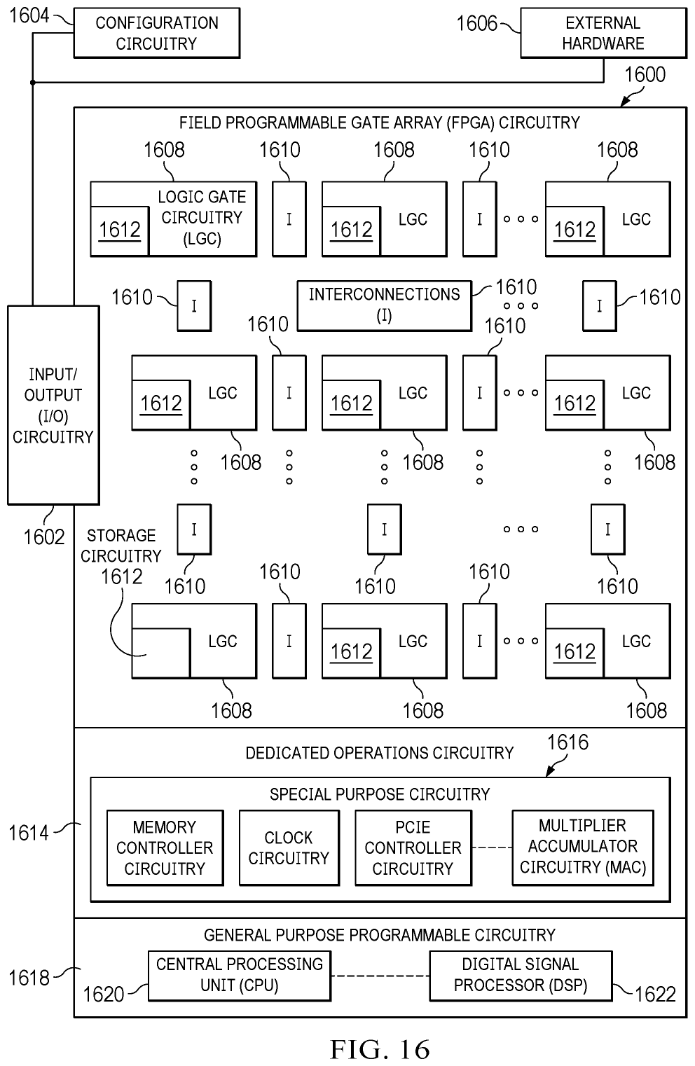

In some examples, the CPA circuitry 402 is instantiated by programmable circuitry executing CPA instructions or configured to perform operations such as those represented by the flowchart of FIG. 7. In some examples, the PCW generator circuitry 102 includes means for generating a carrier profile. For example, the means for generating a carrier profile may be implemented by the CPA circuitry 402. In some examples, the CPA circuitry 402 may be instantiated by programmable circuitry such as the example programmable circuitry 1412 of FIG. 14. For instance, the CPA circuitry 402 may be instantiated by the example microprocessor 1500 of FIG. 15 executing machine-executable instructions such as those implemented by at least the flowchart of FIG. 7. In some examples, the CPA circuitry 402 may be instantiated by hardware logic circuitry, which may be implemented by an ASIC, XPU, or the FPGA circuitry 1600 of FIG. 16 configured or structured to perform operations corresponding to the machine-readable instructions. Also or alternatively, the CPA circuitry 402 may be instantiated by any other combination of hardware, software, or firmware. For example, the CPA circuitry 402 may be implemented by at least one or more hardware circuits (e.g., processor circuitry, discrete analog circuitry, integrated analog circuitry, digital circuitry, an FPGA, an ASIC, an XPU, a comparator, an operational-amplifier (op-amp), a logic circuit, etc.) configured or structured to execute some or all of the machine-readable instructions or to perform some or all of the operations corresponding to the machine-readable instructions without executing software or firmware, but other structures are likewise appropriate.

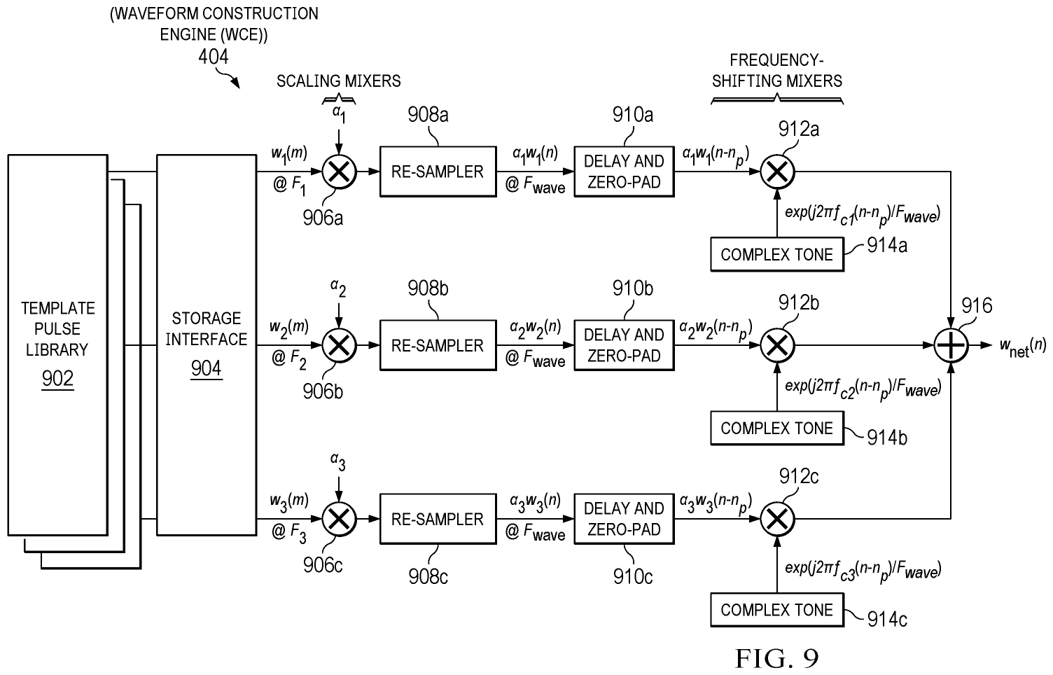

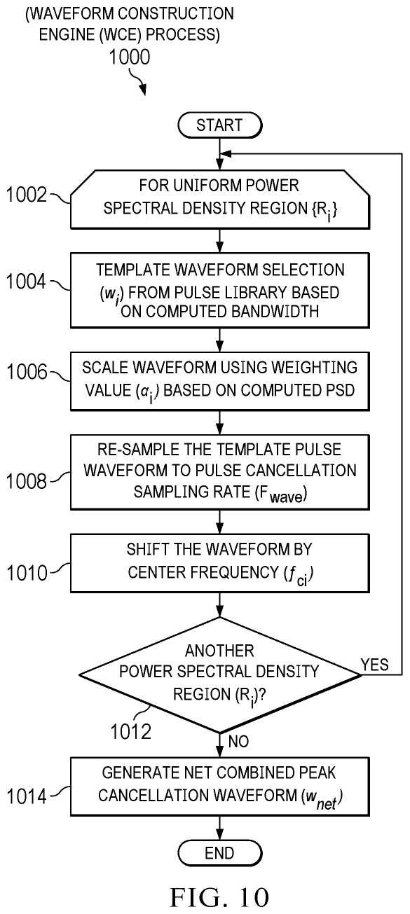

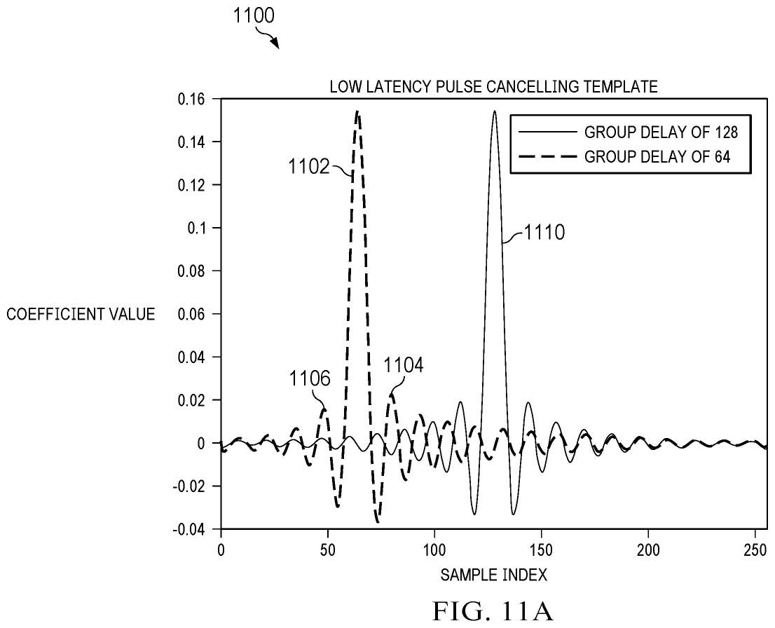

The WCE circuitry 404 generates peak cancellation waveforms as described below in connection with FIGS. 9 and 10. For example, the WCE circuitry 404 can use a carrier profile provided by the CPA circuitry 402 to generate a peak cancellation waveform that is tuned or matched to a corresponding portion of an input signal based on that carrier profile. In this manner, CFR error power (e.g., power leakage across bands) due to adding a cancelling pulse to an input signal primarily falls in-band for the band corresponding to the peak cancellation waveform used to generate the cancelling pulse.

In some examples, the WCE circuitry 404 is instantiated by programmable circuitry executing WCE instructions or configured to perform operations such as those represented by the flowchart of FIG. 10. In some examples, the PCW generator circuitry 102 includes means for generating a peak cancellation waveform. For example, the means for generating a peak cancellation waveform may be implemented by the WCE circuitry 404. In some examples, the WCE circuitry 404 may be instantiated by programmable circuitry such as the example programmable circuitry 1412 of FIG. 14. For instance, the WCE circuitry 404 may be instantiated by the example microprocessor 1500 of FIG. 15 executing machine-executable instructions such as those implemented by at least the flowchart of FIG. 10. In some examples, the WCE circuitry 404 may be instantiated by hardware logic circuitry, which may be implemented by an ASIC, XPU, or the FPGA circuitry 1600 of FIG. 16 configured or structured to perform operations corresponding to the machine-readable instructions. Also or alternatively, the WCE circuitry 404 may be instantiated by any other combination of hardware, software, or firmware. For example, the WCE circuitry 404 may be implemented by at least one or more hardware circuits (e.g., processor circuitry, discrete analog circuitry, integrated analog circuitry, digital circuitry, an FPGA, an ASIC, an XPU, a comparator, an operational-amplifier (op-amp), a logic circuit, etc.) configured or structured to execute some or all of the machine-readable instructions or to perform some or all of the operations corresponding to the machine-readable instructions without executing software or firmware, but other structures are likewise appropriate.

The PCD circuitry 406 sends trigger signals to the CPA circuitry 402 to provide current carrier profiles of corresponding portions of an input signal to the PCD circuitry 406 and the WCE circuitry 404. The PCD circuitry 406 tracks and detects changes in carrier profiles by comparing the current carrier profiles to a previous carrier profile to determine whether to notify the WCE circuitry 404 to generate an updated peak cancellation waveform. Accordingly, when the PCD circuitry 406 detects a change or difference between the current carrier profile and a previous carrier profile, the PCD circuitry 406 causes a re-configuration of the PC-CFR core components. For example, the PCD circuitry 406 sends a re-compute trigger to the WCE circuitry 404 to generate an updated PCW based on new characteristics of a corresponding portion of an input signal represented in the current carrier profile. In some examples, the PCD circuitry 406 causes PCW updates to one CFR stage 408, 410, 412 of the CFR circuitry 301 at a time in a latency matched way, to minimize transient effects.

Also when a change is detected, the PCD circuitry 406 saves the current carrier profile as the previous carrier profile. In this manner, the PCD circuitry 406 can compare the updated previous carrier profile with a next carrier profile for a subsequent portion of the input signal. In some examples, a current portion of the input signal corresponding to the updated previous carrier profile is contiguous with a next portion of the input signal for which the PCD circuitry 406 compares a next carrier profile with the updated previous carrier profile. In other examples, the current portion and the next portion of the input signal are separated by one or more intervening portion(s) of the input signal.

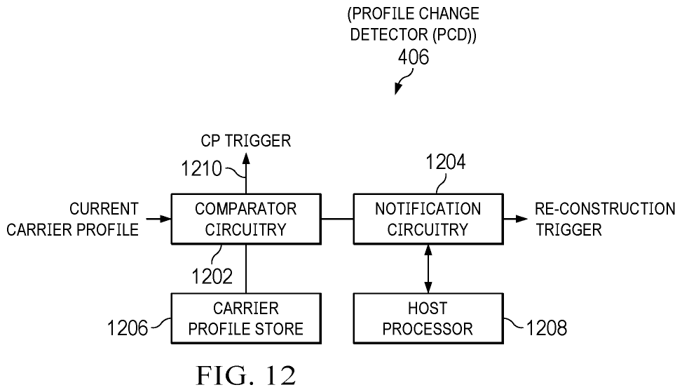

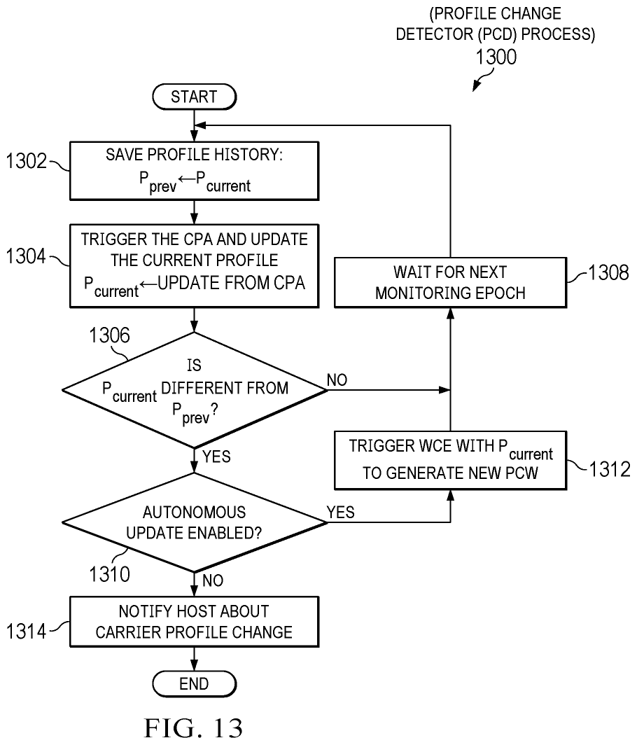

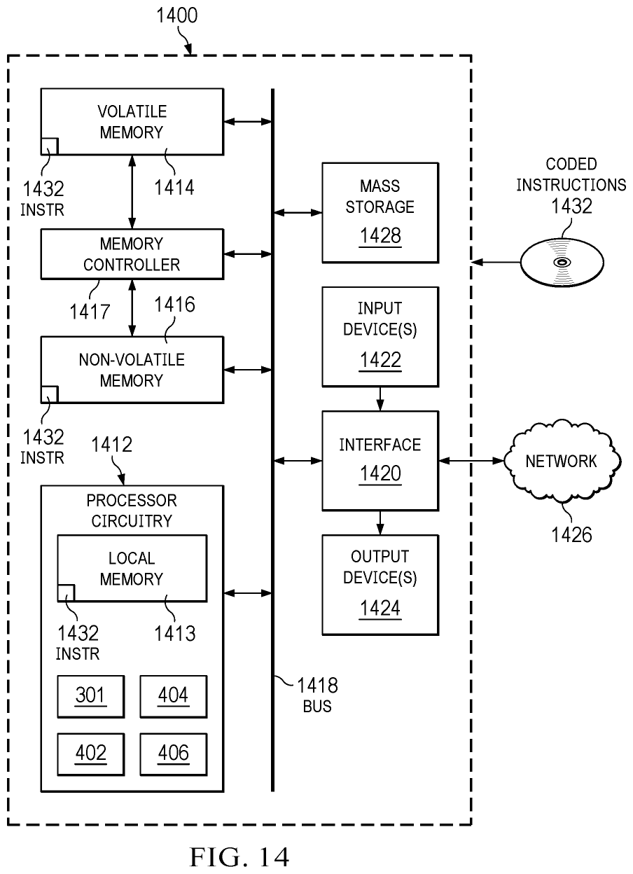

The WCE circuitry 404 stores the updated peak cancellation waveform in the peak cancellation waveform buffer circuitry 426 for use by the first CFR stage circuitry 408. In this manner, the updated peak cancellation waveform will more closely match a peak in that corresponding portion of the input signal detected by the envelope crossing detector circuitry 418 for purposes of reducing or eliminating the amplitude of that peak. The PCD circuitry 406 is described in further detail below in connection with FIGS. 12 and 13.

In some examples, the PCD circuitry 406 is instantiated by programmable circuitry executing PCD instructions or configured to perform operations such as those represented by the flowchart of FIG. 13. In some examples, the PCW generator circuitry 102 includes means for detecting a change between carrier profiles. For example, the means for detecting a change between carrier profiles may be implemented by the PCD circuitry 406. In some examples, the PCD circuitry 406 may be instantiated by programmable circuitry such as the example programmable circuitry 1412 of FIG. 14. For instance, the PCD circuitry 406 may be instantiated by the example microprocessor 1500 of FIG. 15 executing machine-executable instructions such as those implemented by at least the flowchart of FIG. 13. In some examples, the PCD circuitry 406 may be instantiated by hardware logic circuitry, which may be implemented by an ASIC, XPU, or the FPGA circuitry 1600 of FIG. 16 configured or structured to perform operations corresponding to the machine-readable instructions. Also or alternatively, the PCD circuitry 406 may be instantiated by any other combination of hardware, software, or firmware. For example, the PCD circuitry 406 may be implemented by at least one or more hardware circuits (e.g., processor circuitry, discrete analog circuitry, integrated analog circuitry, digital circuitry, an FPGA, an ASIC, an XPU, a comparator, an operational-amplifier (op-amp), a logic circuit, etc.) configured or structured to execute some or all of the machine-readable instructions or to perform some or all of the operations corresponding to the machine-readable instructions without executing software or firmware, but other structures are likewise appropriate.

In some examples, the WCE circuitry 404 can be used without the CPA circuitry 402 and the PCD circuitry 406. In such examples, a host system specifies a carrier profile and the WCE circuitry 404 is triggered to use that host-provided carrier profile information to compute a suitable PCW. In such examples, the CPA circuitry 402 and the PCD circuitry 406 can be completely omitted/bypassed (e.g., the PCW generator circuitry 102 may operate in a bypass mode) or used for consistency checks. For example, the CPA circuitry 402 can be used to determine an actual carrier profile of an input signal and the PCD circuitry 406 can be used to confirm that the host-provided carrier profile is not inconsistent (e.g., beyond a threshold) with the actual carrier profile.

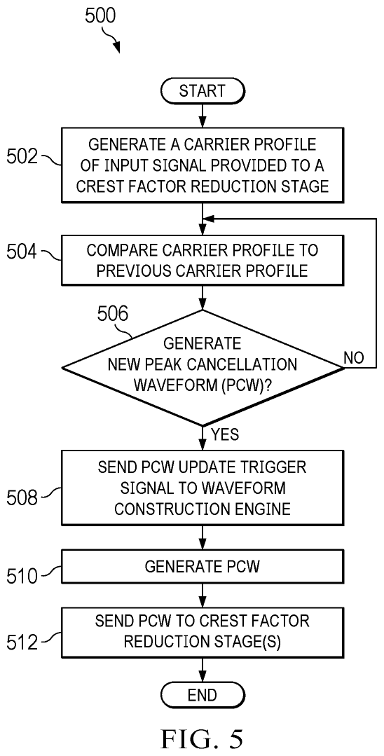

FIG. 5 is a flowchart representative of example machine-readable instructions or example operations 500 that may be executed, instantiated, or performed using an example programmable or non-programmable circuit implementation of the PCW generator circuitry 102 of FIGS. 1 and 4 to generate peak cancellation waveforms. The example instructions or operations 500 begin at block 502 at which the CPA analyzer circuitry 402 generates a carrier profile of an input signal provided to the first crest factor reduction stage 408. The PCD circuitry 406 compares the carrier profile of block 502 to a previous carrier profile (block 504). For example, the carrier profile of block 502 corresponds to the current portion of an input signal and the previous carrier profile corresponds to a previous portion of the input signal. In some examples, the previous portion and the current portion of the input signal are contiguous. In other examples, the previous portion and the current portion of the input signal are separated by one or more intervening portion(s) of the input signal. The PCD circuitry 406 determines whether a new peak cancellation waveform (PCW) needs to be generated (block 506). For example, the PCD circuitry 406 determines a new peak cancellation waveform is to be generated if there is any difference between the carrier profile generated at block 502 and a previous carrier profile. Alternatively, the PCD circuitry 406 determines that a new peak cancellation waveform is to be generated if there is a sufficient difference between the carrier profile generated at block 502 and the previous carrier profile. In such examples, a sufficient difference is a difference between the current and previous carrier profiles that satisfies a threshold (e.g., exceeds a threshold difference). Such threshold may be selected based on an amount of EVM or ACLR that can be tolerated for an input signal or a corresponding portion of the input signal.

If the PCD circuitry 406 determines that a new peak cancellation waveform does not need to be generated (block 506: NO), control returns to block 504. However, if the PCD circuitry 406 determines that a new PCW is to be generated (block 506: YES), control advances to block 508 at which the PCD circuitry 406 sends a PCW update trigger signal to the WCE circuitry 404. The WCE circuitry 404 generates a PCW (block 510). For example, the WCE circuitry 404 generates a new PCW based on the carrier profile generated at block 502. The WCE circuitry 404 sends the PCW to one or more crest factor reduction stages 408, 410, 412 (block 512). The example instructions or operations 500 of FIG. 5 end.

FIG. 6 is a block diagram of an example implementation of the CPA circuitry 402 of FIG. 4. The CPA circuitry 402 includes example capture buffer circuitry 602, example frequency spectrum analyzer circuitry 604, example spectrum analyzer controller circuitry 606, example output buffer circuitry 608, example power spectral analyzer circuitry 610, and example profile generator circuitry 612. The output buffer circuitry 608 has an input terminal and an output terminal. Each of the capture buffer circuitry 602, the frequency spectrum analyzer circuitry 604, the power spectrum analyzer circuitry 610, and the profile generator circuitry 612 has a first input terminal, a second input terminal, and an output terminal. The spectrum analyzer controller circuitry 606 has first, second, and third output terminals.

The input terminal of the capture buffer circuitry 602 receives input data. For example, the input data is the input baseband signal provided to the input terminal of the first CFR stage 408 and the input terminal of the PCW generator 102, as shown in FIG. 4. The capture buffer circuitry 602 may be implemented using a memory (e.g., a static random access memory (SRAM), a dynamic random access memory (DRAM), etc.) to store digital samples of portions of the input baseband signal.

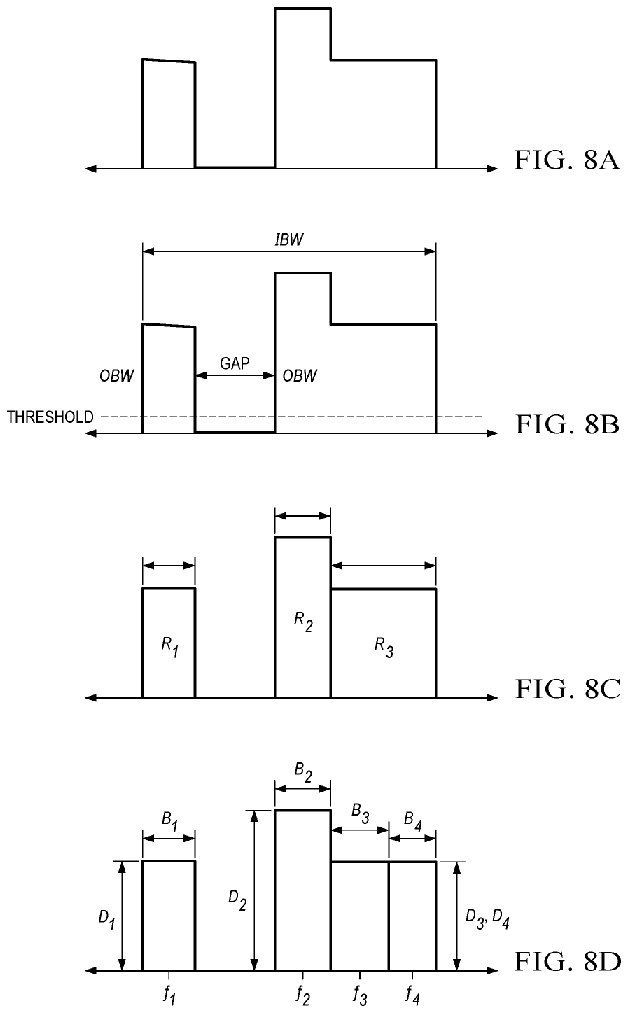

The output terminal of the capture buffer circuitry 602 is coupled to the first input terminal of the frequency spectrum analyzer circuitry 604. The frequency spectrum analyzer circuitry 604 is implemented to analyze frequency spectrums of portions of input signals stored in the capture buffer circuitry 602 and determine power spectral densities (D) for those portions. For example, the power spectral densities (D) correspond to the frequency ranges in a portion of an input signal. Example power spectral densities (D) are illustrated on a frequency grid in FIGS. 8A-8D. When examples described herein are implemented in connection with 5G/New Radio (NR) communication systems, the frequency spectrums analyzed by the frequency spectrum analyzer circuitry 604 correspond to 15 carrier (channel) bandwidths defined in Frequency Range 1 (FR1) of the 5G/NR standards. Those 15 carrier bandwidths include {5, 10, 15, 20, 25, 30, 35, 40, 45, 50, 60, 70, 80, 90, 100} megahertz (MHz). In such examples, the carrier bandwidths are multiples of 5 MHz and fall within a maximum bandwidth of 100 MHz. In some examples, the frequency spectrum analyzer circuitry 604 may be implemented using a Fast Fourier Transform (FFT).

The output terminal of the frequency spectrum analyzer circuitry 604 is coupled to the input terminal of the output buffer circuitry 608. The output buffer circuitry 608 may be implemented using a memory (e.g., a static random access memory (SRAM), a dynamic random access memory (DRAM), etc.) to store digital data representative of the power spectral densities (D) determined by the frequency spectrum analyzer circuitry 604.

The output terminal of the output buffer circuitry 608 is coupled to the first input terminal of the power spectrum analyzer circuitry 610. The power spectrum analyzer circuitry 610 computes improved power spectral densities (D) for portions of input signals based on the power spectral density (D) data stored in the output buffer circuitry 608. For example, the power spectrum analyzer circuitry 610 can employ peak hold averaging techniques (e.g., using an averaged periodogram) to reduce noise by averaging multiple power spectral density (D) captures or representations of a portion of an input signal and determine a more accurate power spectral density for that portion.

The output terminal of the power spectrum analyzer circuitry 610 is coupled to the first input terminal of the profile generator circuitry 612. The profile generator circuitry 612 analyzes the power spectral densities (D) generated by the power spectrum analyzer circuitry 610 and the frequency spectrum representations generated by the frequency spectrum analyzer circuitry 604 to determine center frequency (f), bandwidth (B), and power spectral density (D) characteristics of the portions of the input signals. The profile generator circuitry 612 uses the characteristics to generate carrier profiles as sets of triplets (e.g., a carrier profile=set of (center frequency (f), bandwidth (B), power spectral density (D)) triplets represented as {(f_{c1}, B₁, D₁), (f_{c2}, B₂, D₂), . . . (f_{cN}, B_{N}, D_{N})}).

The first output terminal of the spectrum analyzer controller circuitry 606 is coupled to the second input terminal of the capture buffer circuitry 602. The second output terminal of the spectrum analyzer controller circuitry 606 is coupled to the second input terminal of the frequency spectrum analyzer circuitry 604. The third output terminal of the spectrum analyzer controller circuitry 606 is coupled to the second input terminal of the power spectrum analyzer circuitry 610 and the second input terminal of the profile generator circuitry 612. The spectrum analyzer controller circuitry 606 coordinates operations of the capture buffer circuitry 602, the frequency spectrum analyzer circuitry 604, the power spectrum analyzer circuitry 610, and the profile generator circuitry 612. For example, the spectrum analyzer controller circuitry 606 sends trigger signals to the capture buffer circuitry 602 to capture and store digital samples of portions of input signals. After digital samples are captured and stored in the capture buffer circuitry 602, the spectrum analyzer controller circuitry 606 sends a trigger signal to the frequency spectrum analyzer circuitry 604 to generate one or more frequency spectrum representations based on the digital samples in the capture buffer circuitry 602. After one or more frequency spectrum representations are generated by the frequency spectrum analyzer circuitry 604 and stored in the output buffer circuitry 608, the spectrum analyzer controller circuitry 606 sends a trigger signal to the power spectrum analyzer circuitry 610 to determine one or more power spectral densities based on the one or more frequency spectrum representations in the output buffer circuitry 608. After one or more power spectral densities are generated by the power spectrum analyzer circuitry 610, the spectrum analyzer controller circuitry 606, sends a trigger signal to the profile generator circuitry 612 to generate a carrier profile.

FIG. 7 is a flowchart representative of example machine-readable instructions or example operations 700 that may be executed, instantiated, or performed using an example programmable or non-programmable circuit implementation of the CPA circuitry 402 of FIGS. 4 and 6 to determine carrier profiles of input signals. The instructions or operations 700 begin at block 701 at which the capture buffer circuitry 602 captures data. For example, the capture buffer circuitry 602 can capture digital samples of a portion of an input signal input to the Tx circuitry 112. The frequency spectrum analyzer circuitry 604 computes a power spectral density (block 702). For example, the frequency spectrum analyzer circuitry 604 uses an FFT process to determine a power spectral density of the portion of the input signal for which digital samples are stored in the capture buffer circuitry 602. The power spectrum analyzer circuitry 610 employs a peak holding average technique across multiple power spectral density (D) captures to improve a power spectral density estimate (block 704). For example, to get a better estimate of power spectral density, multiple captures of power spectral density (D) data for the portion of the input signal are combined either by averaging over those captures or by picking the peak among them for the particular frequency. An example power spectral density is shown in a frequency grid in FIG. 8A.

The profile generator circuitry 612 identifies instantaneous bandwidth (IBW) of a power spectral density (block 706). The profile generator circuitry 612 identifies inter-carrier gaps between carrier bandwidths in the power spectral density (block 708). The profile generator circuitry 612 identifies occupied bandwidth (OBW) (block 710). For example, the profile generator circuitry 612 can determine the IBW at block 706, the inter-carrier gaps at block 708, and the OBW at block 710 based on a per-bin power threshold analysis, as shown in the example power spectral density representation of FIG. 8B. In communication systems, the IBW and the OBW characterize a carrier profile of a transmit signal. The OBW includes a discrete set of carriers, and the IBW is the full edge-to-edge frequency span of the transmission, as shown in FIG. 8B. When there are inter-carrier gaps between carrier bandwidths of a transmission signal, the IBW can be larger than the OBW (e.g., IBW≥OBW). For example, in a baseband signal spectrum having four carrier bandwidths (e.g., B₁, B₂, B₃, B₄) and a first inter-carrier gap (G₁) between the first carrier bandwidth (B₁) and the second carrier bandwidth (B₂), as shown in FIG. 8D, that baseband signal spectrum has an IBW that is greater than its OBW (e.g., IBW=(B₁+G₁+B₂+B₃+B₄)≥OBW=(B₁+B₂+B₃+B₄)). At block 706, the profile generator circuitry 612 identifies the IBW by detecting carrier bandwidths that satisfy a threshold power level. For any bandwidth that does not satisfy a threshold power level, that frequency range is designated as an inter-carrier gap. Accordingly, the profile generator circuitry 612 can identify the inter-carrier gaps at block 708 and determine the OBW based on the carrier bandwidths detected as satisfying the threshold power level at block 710.

The profile generator circuitry 612 identifies power special density level boundaries (block 712). For example, the profile generator circuitry 612 determines boundaries between different carrier bandwidths in the power spectral density based on the threshold power level applied at block 706. For example, the profile generator circuitry 612 identifies boundaries between carrier bandwidths and adjacent inter-carrier gaps and between adjacent carrier bandwidths having different power levels. The profile generator circuitry 612 identifies uniform power spectral density regions {Rᵢ} in an OBW (block 714). For example, referring to FIG. 8C, the profile generator circuitry 612 segments three uniform power spectral density regions {R₁, R₂, R₃} in the OBW based on respective uniform power spectral densities of those regions. Accordingly, the first uniform power spectral density region {R₁} is identified separate from the second and third uniform power spectral density regions {R₂, R₃} because of an inter-carrier gap between the first uniform power spectral density region {R₁} and the second uniform power spectral density region {R₂}. Similarly, the second uniform power spectral density region {R₂} is identified separate from the third uniform power spectral density region {R₃} because the power level of the second uniform power spectral density region {R₂} is greater than (e.g., not uniform with) the power level of the third uniform power spectral density region {R₃}. For implementations in a 5G/NR communication system, the profile generator circuitry 612 parses contiguous regions of bandwidth into uniform power spectral density regions {Rᵢ} at block 714 by rounding to the nearest 5 MHz. For example, in FIG. 8C, the profile generator circuitry 612 parses out the second uniform power spectral density region {R₂} and the third uniform power spectral density region {R₃} form a contiguous bandwidth region based on the nearest 5 MHz boundary between the 2 regions. Although not shown, the uniform power spectral density regions {Rᵢ} are separated by guard bands.

The profile generator circuitry 612 segments each uniform power spectral density region into a minimal set of allowed carrier bandwidths (block 716). Referring to FIG. 8D, the profile generator circuitry 612 segments the three uniform power spectral density regions {R₁, R₂, R₃} into four carrier bandwidth regions (B₁, B₂, B₃, B₄). In example FIG. 8D, the first carrier bandwidth region (B₁) corresponds to the first uniform power spectral density region {R₁} of FIG. 8C, the second carrier bandwidth region (B₂) corresponds to the second uniform power spectral density region {R₂} of FIG. 8C, the third carrier bandwidth region (B₃) corresponds to a first portion of the third uniform power spectral density region {R₃} of FIG. 8C, and the fourth carrier bandwidth region (B₄) corresponds to a second portion of the third uniform power spectral density region {R₃} of FIG. 8C. In such example, the third uniform power spectral density region {R₃} is partitioned into the third carrier bandwidth region (B₃) and the fourth carrier bandwidth region (B₄) because the third uniform power spectral density region {R₃} spans across two carrier bandwidths of a set of bandwidths in a communication system. The second, third, and fourth carrier bandwidth regions (B₂, B₃, B₄) are contiguous bandwidth regions having different underlying bandwidths. For example, to segment each uniform power spectral density region {Rᵢ} into a minimalist bandwidth partition of constituent 5G/NR carriers, for a region spanning less than or equal to 100 MHz, at most two carriers would be needed. For example, if the combined bandwidth of the third and fourth carrier bandwidth regions is equal to a 75 MHz contiguous bandwidth region (e.g., B₃+B₄=75 MHz), under the 5G/NR specification, that contiguous bandwidth region can be parsed into two underlaying bandwidths of B₃=25 MHz and B₄=50 MHz. Also, for a region spanning greater than 100 MHz, one or more 100 MHz carriers and up to two sub-100 MHz carriers could be used. For example, if the combined bandwidth of the third and fourth carrier bandwidth regions is equal to a 125 MHz contiguous bandwidth region (e.g., B₃+B₄=125 MHz), under the 5G/NR specification, that contiguous bandwidth region can be parsed into two underlaying bandwidths of B₃=100 MHz and B₄=25 MHz.

The profile generator circuitry 612 finds the center frequency (f_{Ci}) of each carrier bandwidth region (block 718). For example, referring to FIG. 8D, the profile generator circuitry 612 determines the four center frequencies (f₁,f₂,f₃,f₄). For the four carrier bandwidth regions (B₁, B₂, B₃, B₄). The profile generator circuitry 612 constructs a carrier profile as a set of triplets (e.g., a carrier profile=set of (center frequency (f), bandwidth (B), power spectral density (D)) triplets represented as {(f_{c1}, B₁, D₁), (f_{c2}, B₂, D₂), . . . (f_{cN}, B_{N}, D_{N})}) (block 720). For example, the profile generator circuitry 612 generates a first triplet based on the characteristics (f_{c1}, B₁, D₁) of the first carrier bandwidth regions (B₁), generates a second triplet based on the characteristics (f_{c2}, B₂, D₂) of the second carrier bandwidth regions (B₂), generates a third triplet based on the characteristics (f_{c3}, B₃, D₃) of the third carrier bandwidth regions (B₃), and generates a fourth triplet based on the characteristics (f_{c4}, B₄, D₄) of the fourth carrier bandwidth regions (B₄). The profile generator circuitry 612 can store the set of triplets as a data structure in a memory (e.g., SRAM, DRAM, etc.) for access by the WCE circuitry 404. The example instructions or operations 700 of FIG. 7 end.

FIG. 9 is a block diagram of an example implementation of the WCE circuitry 404 of FIG. 4. The WCE circuitry 404 may be used to generate the composite peak cancellation waveform to cancel peaks in input signals having signal profiles defined by a set of carriers {Cᵢ}. In such examples, each carrier {Cᵢ} is defined by a triplet of parameters or characteristics (fᵢ, Bᵢ, Dᵢ). In example FIG. 9, for each carrier {Cᵢ}, a peak-normalized pulse waveform wᵢ(n) having a unit peak at n=nₚ (i.e., wᵢ(nₚ)=1) is available at a sampling rate F_{wave}. As used herein, F_{wave} is a pulse cancellation sampling rate that is related to the baseband data sampling rate through an Oversampling Ratio (OSR): F_{wave}=OSR*Fᵢₙₜ, where Fᵢₙₜ is the original sampling rate of the input signal. As used herein, an OSR defines a sampling rate multiplier by which to increase the original sampling rate, Fᵢₙₜ, of the input signal to achieve a higher resolution pulse cancellation sampling rate of F_{wave}. A suitable OSR is selected as described below to detect peaks that may be hidden between samples of lower-resolution sampling rates. If the waveforms of the carriers {Cᵢ} have peaks at different indices, they are appropriately zero-padded and latency aligned using delay and zero-pad circuitry so that they have a common peak location or common peak index nₚ. Accordingly, the composite PCW for this signal profile can be constructed according to Equation 2 and Equation 3 below.

$${α}_{i} = ( \frac{\sqrt{{D}_{i}} {B}_{i}}{{\sum }_{k} \sqrt{{D}_{k}} {B}_{k}} ) \qquad Equation 2$$

$${w}_{net} ( n ) = {\sum }_{i} {α}_{i} {w}_{i} ( n ) {e}^{j 2 π {f}_{{c}_{i}} ( n - {n}_{p} ) / {F}_{wave}} \qquad Equation 3$$

$$where$$

$$j = \sqrt{- 1}$$

A specific weightage {αᵢ} of Equation 2 above is determined on a per-carrier {Cᵢ} basis based on a computed power spectral density (D) for that carrier {Cᵢ}. The weight {αᵢ} is used to ensure or increase the likelihood of a uniform in-band SNR/EVM impact (e.g., to make little or no change to neighboring frequencies) for each carrier {Cᵢ} of corresponding constituent peak-normalized pulse waveforms wᵢ(n). For example, relative amplitude scales of the different carriers {Cᵢ} are kept proportional to their bandwidths and their square-root of power spectral densities, to achieve a PCW design that has an equal-EVM impact across the carriers {Cᵢ}.

Equation 3 above is used to determine a net combined peak-normalized pulse waveform, wₙₑₜ(n), to use as a PCW to cancel a peak in a portion of an input signal. In Equation 3, the net combined peak-normalized pulse waveform, wₙₑₜ(n), is based on a sum of weighting values {αᵢ} and corresponding constituent peak-normalized pulse waveforms wᵢ(n) for different carriers {Cᵢ} in the carrier profile and based on the sampling rate F_{wave}. Accordingly, the net combined peak-normalized pulse waveform, wₙₑₜ(n), can be referred to as a composite PCW generated based on the multiple constituent peak-normalized pulse waveforms wᵢ(n). For example, the WCE circuitry 404 generates the net combined peak-normalized pulse waveform, wₙₑₜ(n), by scaling or normalizing (e.g., using scaling mixer circuitry 906a, 906b, 906c), interpolating (e.g., using re-sampler circuitry 908a, 908b, 908c), peak latency aligning (e.g., using delay and zero-pad circuitry 910a, 910b, 910c), frequency-shifting (e.g., using frequency-shifting mixer circuitry 912a, 912b, 912c), and combining multiple template waveforms (e.g., using summer circuitry 916) that constitute the carrier profile of a portion of an input signal. The multiple constituent scaled peak-normalized waveforms αᵢwᵢ(n) are zero-padded and delayed to latency align each of their peaks to a common index nₚ. The term

$${e}^{j 2 π {f}_{{c}_{i}} ( n - {n}_{p} ) / {F}_{wave}}$$

in Equation 3 is a complex tone that is mixed into corresponding ones of the multiple zero-padded and latency-aligned constituent peak-normalized pulse waveforms αᵢwᵢ(n−nₚ). The WCE circuitry 404 provides this net combined peak-normalized pulse waveform, wₙₑₜ(n), as the PCW to the peak cancellation waveform buffer circuitry 426 (FIG. 4) for use by the first CFR stage circuitry 408 in the cancellation of peaks in the corresponding portion of the input signal.

In example FIG. 9, before frequency shifting (e.g., by frequency-shifting mixer circuitry 912a, 912b, 912c), real-valued peak-normalized template pulse waveforms wᵢ(m) and the constituent peak-normalized pulse waveforms wᵢ(n) may satisfy a symmetry condition around a corresponding peak location (e.g., wᵢ(nₚ−n)=wᵢ(nₚ+n), in which n represents a time-domain location and nₚ represents a time-domain peak location). As such, the net combined peak-normalized pulse waveform, wₙₑₜ(n), (e.g., a PCW) satisfies a conjugate symmetry condition: wₙₑₜ(nₚ−n)=wₙₑₜ*(nₚ+n). This allows efficient storage and use of the PCW for peak cancellation.

The WCE circuitry 404 is shown in FIG. 9 in a three-band configuration. In the three-band configuration, a PCW (e.g., wₙₑₜ(n)) generated by the WCE circuitry 404 can be used to cancel peaks present in three different bandwidth regions (B₁) of a portion of an input signal. However, the WCE circuitry 404 can be alternatively configured to generate PCWs for use in cancelling peaks in fewer or more bandwidth regions (B₁). For example, the WCE circuitry 404 can be implemented as a four-band configuration to cancel peaks in the four bandwidth regions (B₁, B₂, B₃, B₄) shown in FIG. 8D for a portion of an input signal.

Turning in detail to FIG. 9, the WCE circuitry 404 includes example storage interface circuitry 904, example scaling mixer circuitry 906a, 906b, 906c, example re-sampler circuitry 908a, 908b, 908c, example delay and zero-pad circuitry 910a, 910b, 910c, example frequency-shifting mixer circuitry 912a, 912b, 912c, and example summer circuitry 916. Each of the re-sampler circuitry 908a, 908b, 908c and the delay and zero-pad circuitry 910a, 910b, 910c has an input terminal and output terminal. Each of the scaling mixer circuitry 906a, 906b, 906c and the frequency-shifting mixer circuitry 912a, 912b, 912c has a first input terminal, a second input terminal, and an output terminal. The summer circuitry 916 has a first input terminal, a second input terminal, a third input terminal, and an output terminal.

The storage interface 904 is coupled to an example template pulse library 902. The template pulse library 902 may be implemented using memory circuitry (e.g., SRAM, DRAM, etc.) or storage circuitry (e.g., flash memory, magnetic memory, etc.) to store real-valued peak-normalized template pulse waveforms wᵢ(m). In an alternate example, real-valued peak-normalized template pulse waveforms wᵢ(m) are minimum phase pre-stored template pulse waveforms employed to yield a generic PCW that has lower latency. For example, for each carrier bandwidth {Cᵢ} that could be in an input signal, the template pulse library 902 stores a real-valued peak-normalized template pulse waveform wᵢ(m) at a corresponding template sampling rate corresponding to samples m. As used herein, a template sampling rate is the sampling rate at which a template pulse waveform wᵢ(m) is stored. As used herein, a real-valued peak-normalized template pulse waveform wᵢ(m) represents a waveform using real values m (e.g., sample values m in the same amplitude range as an input signal) and has a peak that is normalized. In this manner, the same real-valued peak-normalized template pulse waveform wᵢ(m) can be used to cancel different peaks. Also the real-valued peak-normalized template pulse waveform wᵢ(m) may be symmetric. In example 5G/NR communications having 15 carrier bandwidths, the template pulse library 902 stores 15 real-valued peak-normalized template pulse waveforms wᵢ(m).

In examples described herein, a different storage-efficient and interpolation-efficient template sampling rate may be selected for each template pulse waveform wᵢ(m) stored in the template pulse library 902. For example, storage efficiency (e.g., memory usage) can be achieved by storing templates using a template sampling rate corresponding to a lowest OSR. Also, interpolation efficiency can be achieved by storing template pulse waveforms wᵢ(m) at a slightly higher OSR so that interpolation complexity is reduced. Interpolation efficiency can be measured in millions of instructions per second (MIPS) as an indicator of an amount of time taken to interpolate a template pulse waveform wᵢ(m) to a desired rate (e.g., OSR*Fᵢₙₜ). As such, trade-offs can be made to select a template sampling rate of a particular template pulse waveform wᵢ(m) that is sufficiently low to achieve a suitable storage efficiency and sufficiently high to achieve a suitably low interpolation efficiency.

For example, four different template sampling rates (1, 2, 4, 8)*X, where X is the sampling rate of the original input signal (e.g., X=61.44 million samples per second (MSPS) for which frequencies are multiples of 61.44 MSPS), can be used to store 15 template pulse waveforms across 15 respective carrier bandwidths {Cᵢ} (e.g., in 5G/NR communications) as follows:
1X for 5, 10, 15 MHz carrier bandwidths
2X for 20, 25 MHz carrier bandwidths
4X for 30, 35, 40, 45, 50, 60 MHz carrier bandwidths
8X for 70, 80, 90, 100 MHz carrier bandwidths.

As a template sampling rate increases, the storage capacity used to store a template pulse waveform wᵢ(m) also increases. A template pulse waveform wᵢ(m) for a 5 MHz input signal stored at a 2X template sampling rate uses twice the storage capacity than a template sampling rate stored with a 1X template sampling rate. To interpolate a 5 MHz template pulse waveform wᵢ(m) stored in a 2X sampling rate to a 4X pulse waveform sampling rate, one interpolation by two can be used. However, two interpolation operations are used to convert a template pulse waveform wᵢ(m) stored at a 1X sampling rate to the 4X pulse waveform sampling rate. Accordingly, while deciding the storage rate, both storage efficiency and interpolation efficiency are considered.

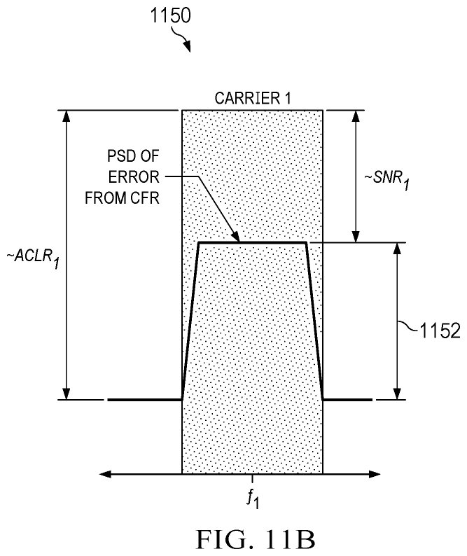

Alternatively, in some examples, the template pulse waveforms wᵢ(m) could be designed for lower latency (e.g., minimum phase waveforms). For example, a template pulse waveform wᵢ(m) can be an asymmetric and real waveform that can be used to generate a complex waveform after frequency shifting (e.g., by the frequency-shifting mixers 912a, 912b, 912c of FIG. 9). Referring briefly to FIG. 11A, an example low-latency pulse cancelling template 1100 shows an example asymmetric waveform 1102 because samples to the right of its maximum peak do not have the same amplitudes as their index-based (e.g., time-based) counterparts on the left side of the maximum peak. For example, an example right-side peak 1104 is not the same amplitude as an index-based counterpart example left-side peak 1106. An example symmetric waveform 1110 is an example of real-valued peak-normalized template pulse waveform wᵢ(m) that is symmetric. The symmetric waveform 1110 has higher latency compared to the asymmetric waveform 1102. The asymmetric waveform 1102 is, for example, a low latency asymmetric template pulse waveform wᵢ(m) (e.g., a real-valued asymmetric template pulse waveform). Due to a group delay of 128 sample indices for the symmetric waveform 1110 and a group delay of 64 sample indices for the asymmetric waveform 1102, the peak location (nₚ) of the symmetric waveform 1110 is at sample index 128 and the peak location (nₚ) of the asymmetric waveform 1102 is at sample index 64.

In some examples, template pulse waveform selection can be made based on an overall PAR target specified by the CFR circuitry 301 (FIG. 3), allowing a finer trade-off between the SNR and ACLR impacts from the CFR circuitry 301. For example, a PAR target can be the combined value of all CFR stages (e.g., the CFR stages 408, 410, 412 of FIG. 4) in the Tx circuitry 112. A PAR target input 440 to the WCE circuitry 404 is shown in FIG. 4. Referring briefly to FIG. 11B, an example carrier bandwidth 1150 is shown with a passband-to-stopband attenuation 1152 for PAR. In example FIG. 11B, as PAR decreases, the SNR degrades more (e.g., more noise due to larger peak cancellations) because higher CFR error power is added in band. In such cases, examples described herein may be used to design a template pulse that has substantially little or no impact on ACLR. In that case for a lower PAR, a higher passband-to-stopband attenuation 1152 is used for selecting a template pulse waveform wᵢ(m) which would also result in a higher latency (peak location (nₚ) and length of template pulse waveform wᵢ(m) will increase). The peak location (nₚ) for a net combined peak-normalized pulse waveform wₙₑₜ(n) is proportional to the latency of CFR. If the PAR is higher, a template pulse waveform wᵢ(m) with a lower passband-to-stopband attenuation 1152 can be selected because the SNR would be higher in that scenario.

In some examples, the template pulse waveforms wᵢ(m) in the template pulse library 902 have time-domain symmetry (e.g., samples on one side of the maximum peak location mirror corresponding samples on the other side of the maximum peak location). In such examples, the template pulse library 902 can increase storage efficiency by storing only one half of each template pulse waveform wᵢ(m).

The storage interface 904 is coupled to the first input terminals of the scaling mixer circuitry 906a, 906b, 906c. Respective weighting values {αᵢ} are provided to the second input terminals of the scaling mixer circuitry 906a, 906b, 906c. For example, the weighting values {αᵢ} may be obtained from respective registers or memory locations of memory (e.g., SRAM, DRAM, cache, etc.). The weighting values {αᵢ} can be determined by a processor (e.g., the processor circuitry 202 of FIG. 2) based on Equation 2 above and applied by the scaling mixer circuitry 906a, 906b, 906c to ensure or increase the likelihood of a uniform in-band SNR/EVM impact for each carrier {Cᵢ} of corresponding constituent peak-normalized pulse waveforms wᵢ(m) characterized in the carrier profile of a portion of an input signal.

The outputs of the scaling mixer circuitry 906a, 906b, 906c are coupled to the inputs of the re-sampler circuitry 908a, 908b, 908c. Since template pulse waveforms wᵢ(m) are stored at specific rates, the re-sampler circuitry 908a, 908b, 908c are used to interpolate them to other supported sampling rates. For example, a waveform sampling rate is Fᵢₙₜ*OSR, where Fᵢₙₜ is the sampling rate at which the CFR circuitry 301 (FIG. 3) receives the samples in the input signal, and OSR is the oversampling ratio factor used to get better resolution to perform peak detection.

The re-sampler circuitry 908a, 908b, 908c use pre-stored interpolation filters to re-sample the selected template pulse waveforms wᵢ(m) to any supported waveform sampling rates (e.g., accounting for selected waveform OSR). In some examples, interpolation filters that support multiple possible factors of interpolation are stored in processor memory. In some examples, a pair of interpolation filters, one for 2× interpolation and one for 3× interpolation, can support re-sampling the template pulse waveforms wᵢ(m) to any of 10 different unique waveform sampling rates (e.g., (1, 1.5, 2, 3, 4, 6, 8, 12, 16, 24)*X, where X=61.44 MSPS, and sampling rates are multiples of X=61.44 with factors containing 3 and powers of 2). The 10 different unique waveform sampling rates can be derived based on template pulse waveform sampling rate and a combination of one or more of interpolation re-sampling or one or more of decimation re-sampling or by a combination of one or more of interpolation re-sampling and one or more of decimation re-sampling. For example, a 10 MHz template pulse waveform wᵢ(m) can be re-sampled from 1X to 1.5X (e.g., if 1.5X is needed for peak cancellation) by employing a 3× interpolation filter and decimating by 2. As another example, a 30 MHz template pulse waveform wᵢ(m) can be re-sampled from 4X to 16X (e.g., if 16X is needed for peak cancellation) by employing a 2× interpolation filter twice in succession. In some examples, symmetry in both the template pulse waveform wᵢ(m) and the interpolation filters is leveraged to store and compute only one half of the pulse at any sampling rate. The outputs of the re-sampler circuitry 908a, 908b, 908c are the constituent peak-normalized pulse waveforms wᵢ(n) of Equation 3 above. The constituent peak-normalized pulse waveforms wᵢ(n) are based on samples n at the re-sampled sampling rate.

The outputs of the re-sampler circuitry 908a, 908b, 908c are coupled to the inputs of the delay and zero-pad circuitry 910a, 910b, 910c. The outputs of the delay and zero-pad circuitry 910a, 910b, 910c are coupled to the first inputs of the frequency-shifting mixer circuitry 912a, 912b, 912c. For waveforms of the carriers {Cᵢ} having peaks at different indices, the delay and zero-pad circuitry 910a, 910b, 910c are provided to appropriately zero-pad and latency-align the peaks so that they have a common peak location or common peak index nₚ. To frequency-shift the latency aligned scaled constituent peak-normalized pulse waveforms by a center frequency (f_{c}_{ᵢ}) of a carrier {Ci} of a corresponding power spectral density region {Ri}, respective example complex tones 914a, 914b, 914c are provided to the second input terminals of the frequency-shifting mixer circuitry 912a, 912b, 912c. For example, the complex tones 914a, 914b, 914c may be obtained from respective memory locations of memory (e.g., SRAM, DRAM, cache, etc.). In example FIG. 9, each complex tone 914a, 914b, 914c is defined based on its corresponding carrier frequency, the current sample index n, and the peak index nₚ. For example, the first complex tone 914a is defined as exp(j2πf_{c}_{ᵢ}(n−nₚ)/F_{wave}), the second complex tone 914b is defined as exp(j2πf_{c}_{ᵢ}(n−nₚ)/F_{wave}), and the third complex tone 914c is defined as exp(j2πf_{c}_{ᵢ}(n−nₚ)/F_{wave}). These complex tones 914a, 914b, 914c, are represented by

$${e}^{j 2 π {f}_{{c}_{i}} ( n - {n}_{p} ) / {F}_{wave}}$$

in Equation 3 in which each complex tone 914a, 914b, 914c is multiplied by a corresponding constituent peak-normalized pulse waveform wᵢ(n) and corresponding weight {αᵢ}.

The output terminals of the frequency-shifting mixer circuitry 912a, 912b, 912c are coupled to the inputs of the summer circuitry 916. The summer circuitry 916 receives the results of multiplying each complex tone 914a, 914b, 914c by corresponding constituent peak-normalized pulse waveforms wᵢ(n) and weights {αᵢ} from the frequency-shifting mixer circuitry 912a, 912b, 912c. The summer circuitry 916 sums these results to generate the net combined peak-normalized pulse waveform, wₙₑₜ(n), based on Equation 3 above to use as a PCW.

FIG. 10 is a flowchart representative of example machine-readable instructions or example operations 1000 that may be executed, instantiated, or performed using an example programmable or non-programmable circuit implementation of the WCE circuitry 404 of FIGS. 4 and 9 to generate PCWs. The instructions or operations 1000 include one or more iterations between blocks 1002 and 1012 to process each uniform power spectral density region {Rᵢ} of a portion of an input signal to generate a corresponding constituent peak-normalized pulse waveform wᵢ(n) shown in Equation 3 above. For example, with reference to the WCE circuitry 404 shown in FIG. 9, each scaling mixer circuitry 906a, 906b, 906c and its corresponding ones of the re-sampler circuitry 908a, 908b, 908c and the frequency-shifting mixer circuitry 912a, 912b, 912c process a different one of the uniform power spectral density regions {R₁} to create a constituent peak-normalized pulse waveform wᵢ(n). Using the WCE circuitry 404 shown in FIG. 9, the iterations between blocks 1002 and 1012 can be performed in parallel.

For a uniform power spectral density region {R₁} (block 1002), a corresponding one of the scaling mixer circuitry 906a, 906b, 906c accesses a template waveform selection from the template pulse library 902 based on a characteristic (e.g., a carrier profile) of the input signal such as a computed bandwidth corresponding to the current power spectral density region {Rᵢ} (block 1004). For example, a corresponding one of the scaling mixer circuitry 906a, 906b, 906c receives a real-valued peak-normalized template pulse waveforms wᵢ(m) from the template pulse library 902.

A corresponding one of the scaling mixer circuitry 906a, 906b, 906c amplitude-scales the real-valued peak-normalized template pulse waveform wᵢ(m) using a weighting value {αᵢ} based on a computed power spectral density (D) and bandwidth (B) for the current power spectral density region {Rᵢ} (block 1006). A corresponding one of the re-sampler circuitry 908a, 908b, 908c re-samples the real-valued peak-normalized template pulse waveforms wᵢ(m) to a pulse cancellation sampling rate (F_{wave}) (block 1008). For example, the re-sampler circuitry 908a, 908b, 908c generates a re-sampled template pulse waveform such as a constituent peak-normalized pulse waveforms wᵢ(n) with samples n at the re-sampled sampling rate (F_{wave}). A corresponding one of the frequency-shifting mixer circuitry 912a, 912b, 912c shifts the scaled constituent peak-normalized pulse waveforms αᵢwᵢ(n) by a center frequency (f_{c}_{ᵢ}) of a carrier {Cᵢ} of the current power spectral density region {Rᵢ} (block 1010). For example, the result of the corresponding one of the frequency-shifting mixer circuitry 912a, 912b, 912c is a scaled, re-sampled, and frequency-shifted constituent peak-normalized pulse waveform

$$( {α}_{i} {w}_{i} ( n ) {e}^{j 2 π {f}_{{c}_{i}} ( n - {n}_{p} ) / {F}_{wave}} )$$

represented in Equation 3 above. If there is another power spectral density region {Rᵢ} to process (block 1012), control returns to block 1002. Otherwise, control advances to block 1014 at which the summer circuitry 916 generates a net combined peak-normalized pulse waveform, wₙₑₜ(n) (e.g., a peak cancellation waveform). For example, the summer circuitry 916 sums the scaled, re-sampled, and frequency-shifted constituent peak-normalized pulse waveform

$$( {α}_{i} {w}_{i} ( n ) {e}^{j 2 π {f}_{{c}_{i}} ( n - {n}_{p} ) / {F}_{wave}} )$$

using Equation 3 above to generate a net combined peak-normalized pulse waveform, wₙₑₜ(n) for use as a PCW. The instructions or operations 1000 of FIG. 10 end.

FIG. 12 is a block diagram of an example implementation of the PCD circuitry 406 of FIG. 4. The PCD circuitry 406 includes example comparator circuitry 1202, example notification circuitry 1204, and an example carrier profile store 1206. The comparator circuitry 1202 has four terminals. The notification circuitry 1204 has three terminals. An input terminal of the comparator circuitry 1202 is coupled to the CPA 402 (FIGS. 4 and 6). A second terminal of the comparator circuitry 1202 is coupled to a terminal of the carrier profile store 1206. A third terminal of the comparator circuitry 1202 is coupled to a first terminal of the notification circuitry 1204. A fourth terminal of the comparator circuitry 1202 is coupled to the second input terminal of the CPA circuitry 402 (FIG. 4). A second terminal of the notification circuitry 1204 is coupled to a terminal of the host processor 1208. A third terminal of the notification circuitry 1204 is coupled to an input terminal of the WCE circuitry 404. In some examples, third terminal of the notification circuitry 1204 is also coupled to the CPA circuitry 402 to trigger the CPA circuitry 402 to provide the current carrier profile to the WCE circuitry 404.

The comparator circuitry 1202 compares a current carrier profile with a previous carrier profile. For example, the comparator circuitry 1202 can obtain the previous carrier profile from the carrier profile store 1206. In some examples, the previous carrier profile was generated by the CPA circuitry 402 for a previous portion of an input signal. The comparator circuitry 1202 sends a carrier profile (CP) trigger signal 1210 to the CPA circuitry 402 to cause the CPA circuitry 402 to provide a current carrier profile to the comparator circuitry 1202. The current carrier profile corresponds to a portion of an input signal that is currently being processed by the CFR circuitry 301. The previous carrier profile stored in the carrier profile store 1206 is the carrier profile corresponding to a PCW most recently generated by the WCE circuitry 404. For example, when the WCE circuitry 404 generates an updated PCW, the carrier profile used by the WCE circuitry 404 to generate that PCW is stored in the carrier profile store 1206. The carrier profile store 1206 may be implemented using any suitable memory circuitry (e.g., SRAM, DRAM, etc.) or storage circuitry (e.g., flash memory, magnetic memory, etc.).

The notification circuitry 1204 sends a re-computation trigger to the WCE circuitry 404 to generate an updated PCW based on current characteristics specified in a current carrier profile of a corresponding portion of an input signal. For example, the notification circuitry 1204 receives an alert or other signal from the comparator circuitry 1202 indicative that a new PCW is to be generated if the comparator circuitry 1202 determines that the current carrier profile is different from the previous carrier profile. In some examples, any amount of difference between the current and previous carrier profiles causes the comparator circuitry 1202 to alert the notification circuitry 1204 that an updated PCW is to be generated. In other examples, carrier profile difference detection is based on a threshold. For example, the comparator circuitry 1202 determines whether a difference between the current and previous carrier profiles satisfies a threshold. If the threshold is satisfied, the comparator circuitry 1202 alerts the notification circuitry 1204 that an updated PCW is to be generated. Otherwise, the comparator circuitry 1202 discards the current carrier profile.

For example, when the carrier profile is a set of triplets (e.g., a carrier profile=set of (center frequency (f), bandwidth (B), power spectral density (D)) triplets represented as {(f_{c1}, B₁, D₁), (f_{c2}, B₂, D₂), . . . (f_{cN}, B_{N}, D_{N})}), a change in bandwidth (Bᵢ) or center frequency (f_{ci}) is declared a profile change. In some examples, a threshold is used to determine whether a change in power spectral density (Dᵢ) is sufficient to generate a new carrier profile. For example, since a power spectral density estimate can be noisy, a threshold can be selected so that a difference between spectral power densities (Dᵢ) of previous and current carrier profiles must satisfy the threshold to declare a profile change. Such threshold may be selected based on an amount of EVM or ACLR that can be tolerated for an input signal or a corresponding portion of the input signal.

In some examples, the notification circuitry 1204 includes an autonomous update setting that can be enabled or disabled. When the autonomous update setting is enabled, the notification circuitry 1204 autonomously sends a computation trigger to the WCE circuitry 404 to generate an updated PCW in response to an alert or other signal from the comparator circuitry 1202 indicative that a new PCW is to be generated. When the autonomous update setting is disabled, the notification circuitry 1204 sends a notification to the host processor 1208 to obtain authorization from the host processor 1208 before triggering the WCE circuitry 404 to generate an updated PCW. For example, the host processor 1208 may have rules on when to authorize an updated PCW. Alternatively, the host processor 1208 may cause presentation of a notification that requests user authorization to allow generation of the updated PCW. In any case, after the host processor 1208 sends an authorization approval to the notification circuitry 1204, the notification circuitry 1204 sends a re-computation trigger to the WCE circuitry 404. In some examples, the comparator circuitry 1202 also sends the CP trigger 1210 to the CPA circuitry 402 (e.g., when the comparator circuitry 1202 detects a carrier profile change) to cause the CPA circuitry 402 to provide the current carrier profile to the WCE circuitry 404 for use by the WCE circuitry 404 to generate an updated PCW based on the current carrier profile.

FIG. 13 is a flowchart representative of example machine-readable instructions or example operations 1300 that may be executed, instantiated, or performed using an example programmable or non-programmable circuit implementation of the PCD circuitry 406 of FIGS. 4 and 12 to determine when a signal carrier profile of an input signal changes. The instructions or operations 1300 begin at block 1302 at which the carrier profile store 1206 stores a current carrier profile as a previous carrier profile (block 1302). In this manner, the comparator circuitry 1202 can retrieve the previous carrier profile from the carrier profile store 1206 to compare with subsequent current carrier profiles.

The comparator circuitry 1202 sends a CP trigger 1210 (FIG. 12) to the CPA circuitry 402 to update and re-assess the current carrier profile (block 1304). The comparator circuitry 1202 compares the current carrier profile to the previous carrier profile to determine whether there is a difference between the two (block 1306). As described above in connection with FIG. 12, the comparator circuitry 1202 may determine that a sufficient difference exists when it detects any amount of difference between the current and previous carrier profiles or when it detects a difference that satisfies a threshold.

If the comparator circuitry 1202 does not detect a difference (block 1306: NO), control advances to block 1308 at which the PCD circuitry 406 waits for the next monitoring epoch (e.g., a next portion of the input signal to be monitored). Otherwise, if the comparator circuitry 1202 does detect a difference (block 1306: YES), control advances to block 1310 at which the notification circuitry 1204 determines whether autonomous update is enabled.

If the notification circuitry 1204 determines that autonomous update is enabled (block 1310: YES), the notification circuitry 1204 sends a re-computation trigger to the WCE circuitry 404 with the current carrier profile (P_{current}) to generate a new PCW (block 1312). For example, the notification circuitry 1204 can send a trigger to the CPA circuitry 402 to cause the CPA circuitry 402 to provide the current carrier profile (P_{current}) to the WCE circuitry 404. The current carrier profile can be used by the WCE circuitry 402 to generate an updated PCW in response to the re-computation trigger from the notification circuitry 1204. In this manner, the WCE circuitry 404 can provide an updated PCW to the peak cancellation waveform buffer circuitry 426 (FIG. 4) of the first CFR stage 408 (and other CFR stages 410, 412). The CFR circuitry 301 can then be re-configured with the updated PCW to generate cancelling pulses to cancel peaks detected in a current portion of the input signal.

If the notification circuitry 1204 determines that autonomous update is not enabled (block 1310: NO), the notification circuitry 1204 notifies the host processor 1208 about the carrier profile change (block 1314). In this manner, the notification circuitry 1204 waits to receive authorization from the host processor 1208, as described above in connection with FIG. 12, before sending a re-computation trigger to the WCE circuitry 404. The example instructions or operations 1300 of FIG. 12 end.

While an example manner of implementing the PCW generator circuitry 102 of FIG. 1 is illustrated in FIG. 4, an example manner of implementing the CPA circuitry 402 is illustrated in FIG. 6, an example manner of implementing the WCE circuitry 404 is illustrated in FIG. 9, and an example manner of implementing the PCD circuitry 406 is illustrated in FIG. 12, one or more of the elements, processes, or devices illustrated in FIGS. 4, 6, 9, and 12 may be combined, divided, re-arranged, omitted, eliminated, or implemented in any other way. Further, the example CPA circuitry 402, the example capture buffer circuitry 602, the example frequency spectrum analyzer circuitry 604, the example spectrum analyzer controller circuitry 606, the example output buffer circuitry 608, the example power spectral analyzer circuitry 610, the example profile generator circuitry 612, the example WCE circuitry 404, the example scaling mixer circuitry 906a, 906b, 906c, the example re-sampler circuitry 908a, 908b, 908c, the example frequency-shifting mixer circuitry 912a, 912b, 912c, the example summer circuitry 916, the example PCD circuitry 406, the example comparator circuitry 1202, and the example notification circuitry 1204 or, more generally, the example PCW generator circuitry 102 of FIG. 4, may be implemented by hardware alone or by hardware in combination with software or firmware. Thus, for example, any of the example CPA circuitry 402, the example capture buffer circuitry 602, the example frequency spectrum analyzer circuitry 604, the example spectrum analyzer controller circuitry 606, the example output buffer circuitry 608, the example power spectral analyzer circuitry 610, the example profile generator circuitry 612, the example WCE circuitry 404, the example scaling mixer circuitry 906a, 906b, 906c, the example re-sampler circuitry 908a, 908b, 908c, the example frequency-shifting mixer circuitry 912a, 912b, 912c, the example summer circuitry 916, the example PCD circuitry 406, the example comparator circuitry 1202, and the example notification circuitry 1204 or, more generally, the example PCW generator circuitry 102, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example PCW generator circuitry 102, the example CPA circuitry 402, the example WCE circuitry 404, and the example PCD circuitry 406 may include one or more elements, processes, or devices in addition to, or instead of, those illustrated in corresponding ones of FIGS. 4, 6, 9, and 12, or may include more than one of any or all of the illustrated elements, processes and devices.

Flowcharts representative of example machine-readable instructions, which may be executed by programmable circuitry to implement or instantiate the PCW generator circuitry 102 of FIG. 4, the example CPA circuitry 402 of FIG. 6, the example WCE circuitry 404 of FIG. 9, or the example PCD circuitry 406 of FIG. 12 or representative of example operations which may be performed by programmable circuitry to implement or instantiate the PCW generator circuitry 102 of FIG. 4, the example CPA circuitry 402 of FIG. 6, the example WCE circuitry 404 of FIG. 9, or the example PCD circuitry 406 of FIG. 12 are shown in FIGS. 5, 7, 10, and 13. The machine-readable instructions may be one or more executable programs or portion(s) of one or more executable programs for execution by programmable circuitry such as the programmable circuitry 1412 shown in the example processor platform 1400 described below in connection with FIG. 14 or may be one or more function(s) or portion(s) of functions to be performed by the example programmable circuitry (e.g., an FPGA) described below in connection with FIG. 15 or 16. In some examples, the machine-readable instructions cause an operation, a task, etc., to be carried out or performed in an automated manner in the real world. As used herein, “automated” means without human involvement.

The program may be embodied in instructions (e.g., software or firmware) stored on one or more non-transitory computer-readable or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), or any other storage device or storage disk. The instructions of the non-transitory computer-readable or machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (e.g., a server and a client hardware device). For example, the client hardware device may be implemented by an endpoint client hardware device (e.g., a hardware device associated with a human or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 5, 7, 10, and 13, many other methods of implementing the example PCW generator circuitry 102, the example CPA circuitry 402, the example WCE circuitry 404, or the example PCD circuitry 406 may alternatively be used. For example, the order of execution of the blocks of the flowchart(s) may be changed, or some of the blocks described may be changed, eliminated, or combined. Also or alternatively, any or all of the blocks of the flow chart may be implemented by one or more hardware circuits (e.g., processor circuitry, discrete analog circuitry, integrated analog circuitry, digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (e.g., a single-core processor (e.g., a single core CPU), a multi-core processor (e.g., a multi-core CPU, an XPU, etc.)). For example, the programmable circuitry may be a CPU or an FPGA located in the same package (e.g., the same integrated circuit (IC) package or in two or more separate housings), one or more processors in a single machine, multiple processors distributed across multiple servers of a server rack, multiple processors distributed across one or more server racks, etc., or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine-executable instructions. For example, the machine-readable instructions may be fragmented and stored on one or more storage devices, disks or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, or executable by a computing device or other machine. For example, the machine-readable instructions may be stored in multiple parts, which are individually compressed, encrypted, or stored on separate computing devices, wherein the parts when decrypted, decompressed, or combined form a set of computer-executable or machine-executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions or the corresponding program(s) can be executed in whole or in part. Thus, machine-readable, computer-readable or machine-readable media, as used herein, may include instructions or program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 5, 7, 10, and 13 may be implemented using executable instructions (e.g., computer-readable or machine-readable instructions) stored on one or more non-transitory computer-readable or machine-readable media. As used herein, the terms non-transitory computer-readable medium, non-transitory computer-readable storage medium, non-transitory machine-readable medium, or non-transitory machine-readable storage medium are expressly defined to include any type of computer-readable storage device or storage disk and to exclude propagating signals and to exclude transmission media. Examples of such non-transitory computer-readable medium, non-transitory computer-readable storage medium, non-transitory machine-readable medium, or non-transitory machine-readable storage medium include optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, or for caching of the information). As used herein, the terms “non-transitory computer-readable storage device” and “non-transitory machine-readable storage device” are defined to include any physical (mechanical, magnetic or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, or redundant array of independent disks (RAID) systems. As used herein, the term “device” refers to physical structure such as mechanical or electrical equipment, hardware, or circuitry that may or may not be configured by computer-readable instructions, machine-readable instructions, etc., or manufactured to execute computer-readable instructions, machine-readable instructions, etc.

FIG. 14 is a block diagram of an example programmable circuitry platform 1400 structured to execute or instantiate the example machine-readable instructions or the example operations of FIGS. 5, 7, 10, and 13 to implement the PCW generator circuitry 102 of FIG. 4. The programmable circuitry platform 1400 can be, for example, a server, a workstation, a self-learning machine (e.g., a neural network), or any other type of computing or electronic device.

The programmable circuitry platform 1400 of the illustrated example includes programmable circuitry 1412. The programmable circuitry 1412 of the illustrated example is hardware. For example, the programmable circuitry 1412 can be implemented by one or more integrated circuits, logic circuits, FPGAs, microprocessors, CPUs, GPUs, DSPs, or microcontrollers from any desired family or manufacturer. The programmable circuitry 1412 may be implemented by one or more semiconductor based (e.g., silicon based) devices. In this example, the programmable circuitry 1412 implements the example CFR circuitry 301, the example CPA circuitry 402, the example WCE circuitry 404, or the example PCD circuitry 406.

The programmable circuitry 1412 of the illustrated example includes a local memory 1413 (e.g., a cache, registers, etc.). The programmable circuitry 1412 of the illustrated example is in communication with main memory 1414, 1416, which includes a volatile memory 1414 and a non-volatile memory 1416, by a bus 1418. The volatile memory 1414 may be implemented by Synchronous Dynamic Random Access Memory (SDRAM), Dynamic Random Access Memory (DRAM), RAMBUS® Dynamic Random Access Memory (RDRAM®), or any other type of RAM device. The non-volatile memory 1416 may be implemented by flash memory or any other desired type of memory device. Access to the main memory 1414, 1416 of the illustrated example is controlled by a memory controller 1417. In some examples, the memory controller 1417 may be implemented by one or more integrated circuits, logic circuits, microcontrollers from any desired family or manufacturer, or any other type of circuitry to manage the flow of data going to and from the main memory 1414, 1416.

The programmable circuitry platform 1400 of the illustrated example also includes interface circuitry 1420. The interface circuitry 1420 may be implemented by hardware based on any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 1422 are coupled to the interface circuitry 1420. The input device(s) 1422 permit(s) a user (e.g., a human user, a machine user, etc.) to enter data or commands into the programmable circuitry 1412. The input device(s) 1422 can be implemented by, for example, a keyboard, a button, a mouse, a touchscreen, a trackpad, or a trackball.

One or more output devices 1424 are also coupled to the interface circuitry 1420 of the illustrated example. The output device(s) 1424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, or speaker. The interface circuitry 1420 of the illustrated example, thus, may include a graphics driver card, a graphics driver chip, or graphics processor circuitry such as a GPU.

The interface circuitry 1420 of the illustrated example also includes a communication device such as a transmitter, a receiver, a transceiver, a modem, a residential gateway, a wireless access point, or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1400 of the illustrated example also includes one or more mass storage discs or devices 1428 to store firmware, software, or data. Examples of such mass storage discs or devices 1428 include magnetic storage devices (e.g., floppy disk, drives, HDDs, etc.), optical storage devices (e.g., Blu-ray disks, CDs, DVDs, etc.), RAID systems, or solid-state storage discs or devices such as flash memory devices or SSDs.

The machine-readable instructions 1432, which may be implemented by the machine-readable instructions of FIGS. 5, 7, 10, and 13, may be stored in the mass storage device 1428, in the volatile memory 1414, in the non-volatile memory 1416, or on at least one non-transitory computer-readable storage medium such as a CD or DVD which may be removable.

FIG. 15 is a block diagram of an example implementation of the programmable circuitry 1412 of FIG. 14. In this example, the programmable circuitry 1412 of FIG. 14 is implemented by a microprocessor 1500. For example, the microprocessor 1500 may be a general-purpose microprocessor (e.g., general-purpose microprocessor circuitry). The microprocessor 1500 executes some or all of the machine-readable instructions of the flowcharts of FIGS. 5, 7, 10, and 13 to effectively instantiate the circuitry of FIGS. 4, 6, 9, and 12 as logic circuits to perform operations corresponding to those machine-readable instructions. In some such examples, the circuitry of FIGS. 4, 6, 9, and 12 is instantiated by the hardware circuits of the microprocessor 1500 in combination with the machine-readable instructions. For example, the microprocessor 1500 may be implemented by multi-core hardware circuitry such as a CPU, a DSP, a GPU, an XPU, etc. Although it may include any number of example cores 1502 (e.g., 1 core), the microprocessor 1500 of this example is a multi-core semiconductor device including N cores. The cores 1502 of the microprocessor 1500 may operate independently or may cooperate to execute machine-readable instructions. For example, machine code corresponding to a firmware program, an embedded software program, or a software program may be executed by one of the cores 1502 or may be executed by multiple ones of the cores 1502 at the same or different times. In some examples, the machine code corresponding to the firmware program, the embedded software program, or the software program is split into threads and executed in parallel by two or more of the cores 1502. The software program may correspond to a portion or all of the machine-readable instructions or operations represented by the flowcharts of FIGS. 5, 7, 10, and 13.

The cores 1502 may communicate by a first example bus 1504. In some examples, the first bus 1504 may be implemented by a communication bus to effectuate communication associated with one(s) of the cores 1502. For example, the first bus 1504 may be implemented by at least one of an Inter-Integrated Circuit (I2C) bus, a Serial Peripheral Interface (SPI) bus, a PCI bus, or a PCIe bus. Also or alternatively, the first bus 1504 may be implemented by any other type of computing or electrical bus. The cores 1502 may obtain data, instructions, or signals from one or more external devices by example interface circuitry 1506. The cores 1502 may output data, instructions, or signals to the one or more external devices by the interface circuitry 1506. Although the cores 1502 of this example include example local memory 1520 (e.g., Level 1 (L1) cache that may be split into an L1 data cache and an L1 instruction cache), the microprocessor 1500 also includes example shared memory 1510 that may be shared by the cores (e.g., Level 2 (L2 cache)) for high-speed access to data or instructions. Data or instructions may be transferred (e.g., shared) by writing to or reading from the shared memory 1510. The local memory 1520 of each of the cores 1502 and the shared memory 1510 may be part of a hierarchy of storage devices including multiple levels of cache memory and the main memory (e.g., the main memory 1414, 1416 of FIG. 14). Higher levels of memory in the hierarchy may exhibit lower access time and have smaller storage capacity than lower levels of memory. Changes in the various levels of the cache hierarchy are managed (e.g., coordinated) by a cache coherency policy.

Each core 1502 may be referred to as a CPU, DSP, GPU, etc., or any other type of hardware circuitry. Each core 1502 includes control unit circuitry 1514, arithmetic and logic (AL) circuitry (sometimes referred to as an ALU) 1516, a plurality of registers 1518, the local memory 1520, and a second example bus 1522. Other structures may be present. For example, each core 1502 may include vector unit circuitry, single instruction multiple data (SIMD) unit circuitry, load/store unit (LSU) circuitry, branch/jump unit circuitry, floating-point unit (FPU) circuitry, etc. The control unit circuitry 1514 includes semiconductor-based circuits structured to control (e.g., coordinate) data movement within the corresponding core 1502. The AL circuitry 1516 includes semiconductor-based circuits structured to perform one or more mathematic or logic operations on the data within the corresponding core 1502. The AL circuitry 1516 of some examples performs integer based operations. In other examples, the AL circuitry 1516 also performs floating-point operations. In yet other examples, the AL circuitry 1516 may include first AL circuitry that performs integer-based operations and second AL circuitry that performs floating-point operations. In some examples, the AL circuitry 1516 may be referred to as an Arithmetic Logic Unit (ALU).

The registers 1518 are semiconductor-based structures to store data or instructions such as results of one or more of the operations performed by the AL circuitry 1516 of the corresponding core 1502. For example, the registers 1518 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1518 may be arranged in a bank as shown in FIG. 15. Alternatively, the registers 1518 may be organized in any other arrangement, format, or structure, such as by being distributed throughout the core 1502 to shorten access time. The second bus 1522 may be implemented by at least one of an I2C bus, a SPI bus, a PCI bus, or a PCIe bus.

Each core 1502 or, more generally, the microprocessor 1500 may include additional or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) or other circuitry may be present. The microprocessor 1500 is a semiconductor device fabricated to include many transistors interconnected to implement the structures described above in one or more integrated circuits (ICs) contained in one or more packages.

The microprocessor 1500 may include or cooperate with one or more accelerators (e.g., acceleration circuitry, hardware accelerators, etc.). In some examples, accelerators are implemented by logic circuitry to perform certain tasks more quickly or efficiently than can be done by a general-purpose processor. Examples of accelerators include ASICs and FPGAs such as those described herein. A GPU, DSP or other programmable device can also be an accelerator. Accelerators may be on-board the microprocessor 1500, in the same chip package as the microprocessor 1500 or in one or more separate packages from the microprocessor 1500.

FIG. 16 is a block diagram of another example implementation of the programmable circuitry 1412 of FIG. 14. In this example, the programmable circuitry 1412 is implemented by FPGA circuitry 1600. For example, the FPGA circuitry 1600 may be implemented by an FPGA. The FPGA circuitry 1600 can be used, for example, to perform operations that could otherwise be performed by the example microprocessor 1500 of FIG. 15 executing corresponding machine-readable instructions. However, once configured, the FPGA circuitry 1600 instantiates the operations or functions corresponding to the machine-readable instructions in hardware and, thus, can often execute the operations/functions faster than they could be performed by a general-purpose microprocessor executing the corresponding software.

More specifically, in contrast to the microprocessor 1500 of FIG. 15 described above (which is a general purpose device that may be programmed to execute some or all of the machine-readable instructions represented by the flowcharts of FIGS. 5, 7, 10, and 13 but whose interconnections and logic circuitry are fixed once fabricated), the FPGA circuitry 1600 of the example of FIG. 16 includes interconnections and logic circuitry that may be configured, structured, programmed, or interconnected in different ways after fabrication to instantiate, for example, some or all of the operations/functions corresponding to the machine-readable instructions represented by the flowcharts of FIGS. 5, 7, 10, and 13. In particular, the FPGA circuitry 1600 may be thought of as an array of logic gates, interconnections, and switches.

The switches can be programmed to change how the logic gates are interconnected by the interconnections, effectively forming one or more dedicated logic circuits (unless and until the FPGA circuitry 1600 is reprogrammed). The configured logic circuits enable the logic gates to cooperate in different ways to perform different operations on data received by input circuitry. Those operations may correspond to some or all of the instructions (e.g., the software or firmware) represented by the flowcharts of FIGS. 5, 7, 10, and 13. As such, the FPGA circuitry 1600 may be configured or structured to effectively instantiate some or all of the operations/functions corresponding to the machine-readable instructions of the flowcharts of FIGS. 5, 7, 10, and 13 as dedicated logic circuits to perform the operations/functions corresponding to those software instructions in a dedicated manner analogous to an ASIC. Therefore, the FPGA circuitry 1600 may perform the operations/functions corresponding to the some or all of the machine-readable instructions of FIGS. 5, 7, 10, and 13 faster than the general-purpose microprocessor can execute the same.

In the example of FIG. 16, the FPGA circuitry 1600 is configured or structured in response to being programmed (or reprogrammed one or more times) based on a binary file. In some examples, the binary file may be compiled or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1600 of FIG. 16 may access or load the binary file to cause the FPGA circuitry 1600 of FIG. 16 to be configured or structured to perform the one or more operations/functions. For example, the binary file may be implemented by a bit stream (e.g., one or more computer-readable bits, one or more machine-readable bits, etc.), data (e.g., computer-readable data, machine-readable data, etc.), or machine-readable instructions accessible to the FPGA circuitry 1600 of FIG. 16 to cause configuration or structuring of the FPGA circuitry 1600 of FIG. 16, or portion(s) thereof.

In some examples, the binary file is compiled, generated, transformed, or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, or otherwise output from the uniform software platform based on the second instructions. In some examples, the FPGA circuitry 1600 of FIG. 16 may access or load the binary file to cause the FPGA circuitry 1600 of FIG. 16 to be configured or structured to perform the one or more operations/functions. For example, the binary file may be implemented by a bit stream (e.g., one or more computer-readable bits, one or more machine-readable bits, etc.), data (e.g., computer-readable data, machine-readable data, etc.), or machine-readable instructions accessible to the FPGA circuitry 1600 of FIG. 16 to cause configuration or structuring of the FPGA circuitry 1600 of FIG. 16, or portion(s) thereof.

The FPGA circuitry 1600 of FIG. 16, includes example input/output (I/O) circuitry 1602 to obtain or output data to/from example configuration circuitry 1604 or external hardware 1606. For example, the configuration circuitry 1604 may be implemented by interface circuitry that may obtain a binary file, which may be implemented by a bit stream, data, or machine-readable instructions, to configure the FPGA circuitry 1600, or portion(s) thereof. In some such examples, the configuration circuitry 1604 may obtain the binary file from a user, a machine (e.g., hardware circuitry (e.g., programmable or dedicated circuitry) that may implement an Artificial Intelligence/Machine Learning (AI/ML) model to generate the binary file), etc., or any combination(s) thereof). In some examples, the external hardware 1606 may be implemented by external hardware circuitry. For example, the external hardware 1606 may be implemented by the microprocessor 1500 of FIG. 15.

The FPGA circuitry 1600 also includes an array of example logic gate circuitry 1608, a plurality of example configurable interconnections 1610, and example storage circuitry 1612. The logic gate circuitry 1608 and the configurable interconnections 1610 are configurable to instantiate one or more operations/functions that may correspond to at least some of the machine-readable instructions of FIGS. 5, 7, 10, and 13 or other desired operations. The logic gate circuitry 1608 shown in FIG. 16 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1608 to enable configuration of the electrical structures or the logic gates to form circuits to perform desired operations/functions. The logic gate circuitry 1608 may include other electrical structures such as look-up tables (LUTs), registers (e.g., flip-flops or latches), multiplexers, etc.

The configurable interconnections 1610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1608 to program desired logic circuits.

The storage circuitry 1612 of the illustrated example is structured to store result(s) of the one or more of the operations performed by corresponding logic gates. The storage circuitry 1612 may be implemented by registers or the like. In the illustrated example, the storage circuitry 1612 is distributed amongst the logic gate circuitry 1608 to facilitate access and increase execution speed.

The example FPGA circuitry 1600 of FIG. 16 also includes example dedicated operations circuitry 1614. In this example, the dedicated operations circuitry 1614 includes special purpose circuitry 1616 that may be invoked to implement commonly used functions to avoid the need to program those functions in the field. Examples of such special purpose circuitry 1616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1600 may also include example general purpose programmable circuitry 1618 such as an example CPU 1620 or an example DSP 1622. Other general purpose programmable circuitry 1618 may also or alternatively be present such as a GPU, an XPU, etc., that can be programmed to perform other operations.

Although FIGS. 15 and 16 illustrate two example implementations of the programmable circuitry 1412 of FIG. 14, many other approaches are contemplated. For example, FPGA circuitry may include an on-board CPU, such as one or more of the example CPU 1620 of FIG. 15. Therefore, the programmable circuitry 1412 of FIG. 14 may also be implemented by combining at least the example microprocessor 1500 of FIG. 15 and the example FPGA circuitry 1600 of FIG. 16. In some such hybrid examples, one or more cores 1502 of FIG. 15 may execute a first portion of the machine-readable instructions represented by the flowcharts of FIGS. 5, 7, 10, and 13 to perform first operation(s)/function(s), the FPGA circuitry 1600 of FIG. 16 may be configured or structured to perform second operation(s)/function(s) corresponding to a second portion of the machine-readable instructions represented by the flowcharts of FIGS. 5, 7, 10, and 13, or an ASIC may be configured or structured to perform third operation(s)/function(s) corresponding to a third portion of the machine-readable instructions represented by the flowcharts of FIGS. 5, 7, 10, and 13.

Some or all of the circuitry of FIG. 4 may, thus, be instantiated at the same or different times. For example, same or different portion(s) of the microprocessor 1500 of FIG. 15 may be programmed to execute portion(s) of machine-readable instructions at the same or different times. In some examples, same or different portion(s) of the FPGA circuitry 1600 of FIG. 16 may be configured or structured to perform operations/functions corresponding to portion(s) of machine-readable instructions at the same or different times.

In some examples, some or all of the circuitry of FIGS. 4, 6, 9, and 12 may be instantiated, for example, in one or more threads executing concurrently or in series. For example, the microprocessor 1500 of FIG. 15 may execute machine-readable instructions in one or more threads executing concurrently or in series. In some examples, the FPGA circuitry 1600 of FIG. 16 may be configured or structured to carry out operations/functions concurrently or in series. Moreover, in some examples, some or all of the circuitry of FIGS. 4, 6, 9, and 12 may be implemented within one or more virtual machines or containers executing on the microprocessor 1500 of FIG. 15.

In some examples, the programmable circuitry 1412 of FIG. 14 may be in one or more packages. For example, the microprocessor 1500 of FIG. 15 or the FPGA circuitry 1600 of FIG. 16 may be in one or more packages. In some examples, an XPU may be implemented by the programmable circuitry 1412 of FIG. 14, which may be in one or more packages. For example, the XPU may include a CPU (e.g., the microprocessor 1500 of FIG. 15, the CPU 1620 of FIG. 16, etc.) in one package, a DSP (e.g., the DSP 1622 of FIG. 16) in another package, a GPU in yet another package, and an FPGA (e.g., the FPGA circuitry 1600 of FIG. 16) in still yet another package.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. As used herein in the context of describing structures, components, items, objects or things, the phrase “at least one of A and B” refers to implementations including any of (1) at least one A, (2) at least one B, or (3) at least one A and at least one B. Similarly, as used herein in the context of describing structures, components, items, objects or things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is not feasible or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used herein, connection references (e.g., attached, coupled, connected, and joined) may include intermediate members between the elements referenced by the connection reference or relative movement between those elements unless otherwise indicated. As such, connection references do not necessarily infer that two elements are directly connected or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, or ordering in any way, but are merely used as labels or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, “approximately,” “about,” or “substantially” modify their subjects/values to recognize the potential presence of variations that occur in real world applications. For example, “approximately,” “about,” or “substantially” may modify dimensions that may not be exact due to manufacturing tolerances or other real world imperfections. For example, “approximately,” “about,” or “substantially” may indicate such dimensions may be within a tolerance range of +/−10% unless otherwise specified herein.

As used herein, the phrase “in communication,” including variations thereof, encompasses direct communication or indirect communication through one or more intermediary components, and does not require direct physical (e.g., wired) communication or constant communication, but rather also includes selective communication at periodic intervals, scheduled intervals, aperiodic intervals, or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to cause configuration or structuring of the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed or hardwired) at a time of manufacturing by a manufacturer to perform the function or may be configurable (or re-configurable) by a user after manufacturing to perform the function or other additional or alternative functions. The configuring may be through firmware or software programming of the device, through a construction or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as resistors, capacitors, or inductors), or one or more sources (such as voltage or current sources) may instead include only the semiconductor elements within a single physical device (e.g., a semiconductor die or integrated circuit (IC) package) and may be adapted to be coupled to at least some of the passive elements or the sources to form the described structure either at a time of manufacture or after a time of manufacture, for example, by an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled in series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; or (iv) incorporated in/on the same printed circuit board.

Modifications are possible in the described examples, and other examples are possible, within the scope of the claims.

From the foregoing, it will be appreciated that example systems, apparatus, articles of manufacture, and methods have been described that perform waveform configuration for crest factor reduction. Described systems, apparatus, articles of manufacture, and methods improve the efficiency of using a computing device by enabling use of PC-CFR in both base stations and repeaters without requiring a priori knowledge of carrier profile information. Since examples described herein monitor input signals for changes in their underlying carrier profiles, the described examples are highly scalable to changes in baseband signal characteristics and transmit power. Also, because examples described herein can be used to replace W-CFR with PC-CFR in repeaters, the described examples can reduce the PAR for a given EVM by 1-2 dB. In doing so, the lower PAR helps achieve higher output power for a given peak swing at the power amplifier, thereby improving coverage and range of base stations and repeaters. Described systems, apparatus, articles of manufacture, and methods are accordingly directed to one or more improvement(s) in the operation of a machine such as a computer or other electronic or mechanical device.

What is claimed is:

1. An apparatus comprising:
crest factor reduction circuitry having a signal input and a peak cancellation waveform input; and
peak cancellation waveform generator circuitry including:
carrier profile analyzer circuitry having a signal input coupled to the signal input of the crest factor reduction circuitry, and having a carrier profile output;
waveform construction circuitry having a carrier profile input coupled to the carrier profile output of the carrier profile analyzer circuitry, having a second input, and having a peak cancellation waveform output coupled to the peak cancellation waveform input of the crest factor reduction circuitry; and
profile change detector circuitry having a carrier profile input coupled to the carrier profile output of the carrier profile analyzer circuitry, and having an output coupled to the second input of the waveform construction circuitry.

2. The apparatus of claim 1, wherein the carrier profile analyzer circuitry includes:
frequency spectrum analyzer circuitry having an output;
a buffer having an input coupled to the output of the frequency spectrum analyzer circuitry, and having an output;
power spectrum analyzer circuitry having an input coupled to the output of the buffer, and having an output; and
profile generator circuitry having an input coupled to the output of the power spectrum analyzer circuitry.

3. The apparatus of claim 1, wherein the waveform construction circuitry includes:
first mixer circuitry having an output;
re-sampler circuitry having an input coupled to the output of the first mixer circuitry, and having an output;
delay and zero-pad circuitry having an input coupled to the output of the re-sampler circuitry, and having an output;
second mixer circuitry having an input coupled to the output of the delay and zero-pad circuitry, and having an output; and
summer circuitry having an input coupled to the output of the second mixer circuitry.

4. The apparatus of claim 1, wherein the profile change detector circuitry (406) includes:
comparator circuitry having an output; and
notification circuitry having an input coupled to the output of the comparator circuitry.

5. The apparatus of claim 4, wherein the notification circuitry has an output coupled to a host processor.

6. The apparatus of claim 1, wherein the crest factor reduction circuitry includes a first stage and a second stage, the first stage having the signal input and the peak cancellation waveform input.

7. A transmitter apparatus comprising:
peak cancellation waveform generator circuitry having an input and an output, and configured to access a carrier profile corresponding to an input signal at the input and provide a peak cancellation waveform at the output based on the carrier profile;
crest factor reduction circuitry having an input coupled to the output of the peak cancellation waveform generator circuitry, and having an output, the crest factor reduction circuitry configured to modify the input signal based on the peak cancellation waveform; and
digital pre-distortion circuitry having an input coupled to the output of the crest factor reduction circuitry.

8. The transmitter apparatus of claim 7, wherein the peak cancellation waveform generator circuitry is configured to generate the peak cancellation waveform by:
accessing a template pulse waveform from storage based on a carrier profile of the input signal;
applying a re-sampling filter to the template pulse waveform to generate a re-sampled template pulse waveform; and
generating the peak cancellation waveform based on the re-sampled template pulse waveform.

9. The transmitter apparatus of claim 7, wherein the peak cancellation waveform generator circuitry is configured to determine the carrier profile by:
identifying a region of occupied bandwidth based on a power spectral density of the input signal;
segmenting a uniform power spectral density region from the region of the occupied bandwidth into at least a first bandwidth region, the first bandwidth region corresponding to a first carrier frequency; and
generating the carrier profile for the input signal based on a characteristic of the first bandwidth region.

10. The transmitter apparatus of claim 7, wherein the crest factor reduction circuitry includes first crest factor reduction stage circuitry having an output coupled to an input of second crest factor reduction stage circuitry.

11. The transmitter apparatus of claim 7, wherein the peak cancellation waveform generator circuitry is configured to generate a previous carrier profile for a first portion of the input signal, the carrier profile corresponding to a second portion of the input signal, the second portion of the input signal contiguous with the first portion of the input signal.

12. The transmitter apparatus of claim 11, wherein the peak cancellation waveform generator circuitry is configured to generate the peak cancellation waveform based on a comparison of the carrier profile to the previous carrier profile indicates that the carrier profile is different from the previous carrier profile.

13. The transmitter apparatus of claim 7, wherein the carrier profile includes at least one of a center frequency, a bandwidth, or a power spectral density of the input signal.

14. An apparatus comprising:
programmable circuitry configured to at least one of instantiate or execute machine-readable instructions to:
generate a carrier profile of an input signal of transmitter circuitry;
compare the carrier profile to a previous carrier profile; and
update a peak cancellation waveform for crest factor reduction responsive to the comparison.

15. The apparatus of claim 14, wherein the programmable circuitry is configured to generate the carrier profile by:
identifying a region of occupied bandwidth based on a power spectral density of the input signal;
segmenting a uniform power spectral density region from the region of the occupied bandwidth into at least a first bandwidth region, the first bandwidth region corresponding to a first center frequency; and
generating the carrier profile for the input signal based on characteristics of the first bandwidth region.

16. The apparatus of claim 15, wherein the programmable circuitry is configured to:
segment the uniform power spectral density region from the region of the occupied bandwidth into a second bandwidth region, the second bandwidth region corresponding to a second center frequency; and
generate the carrier profile based on characteristics of the second bandwidth region and the characteristics of the first bandwidth region.

17. The apparatus of claim 14, wherein the carrier profile includes a center frequency, a bandwidth, and a power spectral density of the input signal.

18. The apparatus of claim 14, wherein the programmable circuitry is configured to generate the peak cancellation waveform by:
accessing a template pulse waveform from storage based on characteristics of the input signal;
applying a re-sampling filter to the template pulse waveform to generate a re-sampled template pulse waveform; and
generating the peak cancellation waveform based on the re-sampled template pulse waveform.

19. The apparatus of claim 18, wherein the apparatus is included in a base station.

20. The apparatus of claim 18, wherein the apparatus is included in a repeater.
